(19) United States
(12) Patent Application Publication
(10) Pub. No.: US 2026/0285361 A1
(43) Pub. Date: Sep. 24, 2026

(54) SYSTEMS AND METHODS FOR ENHANCING CONTROL OF VEHICLES IN MERGING SENARIOS

(71) Applicant: Honda Motor Co., Ltd., Tokyo (JP)

(72) Inventors: Jovin Jeevan D'SA, San Jose, CA (US); Tyler Robert NAES, San Jose, CA (US); Hossein NOURKHIZ MAHJOUB, Ann Arbor, MI (US); Behdad CHALAKI, Ann Arbor, MI (US); Ehsan MORADI PARI, Ann Arbor, MI (US); Paritosh KELKAR, Dearborn, MI (US)

(21) Appl. No.: 19/088,359

(22) Filed: Mar. 24, 2025

(51) Int. Cl. B60W 60/00; G08G 1/04; G08G 1/16; H04W 4/46

(52) U.S. Cl. CPC B60W 60/001; G08G 1/04; G08G 1/167; H04W 4/46

(57) ABSTRACT

A vehicle including a sensor configured to collect data associated with a merge scenario and a controller programmed to execute a first planning methodology, using data received from the sensor, to determine if there is at least one kinematically feasible merge gap defined by at least one traffic vehicle. If the controller determines that there is at least one kinematically feasible merge gap, then the controller identifies a target merge gap and determines a merge plan for merging with the target merge gap. If the controller determines that there is not at least one feasible merge gap, the controller compares the data to a switch criterion to determine if a second planning methodology is required.

### FIELD OF THE INVENTION

The present disclosure relates to vehicular control and navigation and, more particularly, to systems and methods for enhancing control of vehicles in various merge scenarios.

### BACKGROUND

Automated and semi-automated vehicles have become more widespread necessitating improvements in the accuracy and speed in which one or more automatic controls are determined and executed by the vehicle. High density traffic environments, such as may occur with inter-city driving, presents challenges when determining real-time controls for automated and semi-automated vehicles. For example, merging into a main adjacent traffic lane from a merge lane may present a challenge for automated and semi-automated vehicles depending on the wide range of merging conditions that may be present during any given merge scenario, such as, variations in traffic speeds and traffic density and/or differences in merge lane lengths and lane geometries.

Merging occurs when a vehicle in one lane moves laterally into an adjacent lane of traffic. The merging vehicle is responsible for determining whether the merge is possible based on the relative location and speed of the vehicles in the adjacent lane, e.g., the merging vehicle must initially determine if there is a suitable gap for which the merging vehicle may enter laterally into the adjacent lane. The process of merging may be further complicated if the merging vehicle is traveling in a merge lane that is short, thus limiting an amount of time, e.g., computational time, and/or available travel distance that the merging vehicle may use to determine whether or when a merge is possible. In congested traffic scenarios when a merge gap in traffic is not readily available, the merging vehicle may have to rely on vehicles in the adjacent lane to move or to adjust their speed, in order to create a gap, e.g., initiation of a negotiation merge. As such, precise vehicle controls to both determine and execute a merging plan, suitable for particular merge scenarios, need to be determined quickly and efficiently, e.g., computationally, to facilitate enhancing the safety and reliability of the automated and semi-automated vehicle navigation within merge scenarios.

Accordingly, it is desirable to have systems and methods that can enhance vehicle controls, in a manner that facilitates generating optimal and/or more efficient vehicle travel path routes through various merging conditions, while simultaneously improving the computational efficiency and speed at which these vehicle controls are determined.

### BRIEF SUMMARY

In one aspect, a vehicle is provided. The vehicle includes a sensor configured to collect data associated with a merge scenario. The data includes data associated with at least one traffic vehicle. The vehicle includes a controller including at least one memory configured to store program instructions and at least one processor configured to execute the program instructions. The controller is programmed to execute a first planning methodology, using data received from the sensor, to determine if there is at least one kinematically feasible merge gap defined by at least one traffic vehicle. If the controller determines that there is at least one kinematically feasible merge gap, then the controller: identifies a target merge gap that includes one of the at least one determined kinematically feasible merge gap and determines a merge plan for merging with the target merge gap. If the controller determines that there is not at least one feasible merge gap, the controller compares the data to a switch criterion to determine if a second planning methodology is required.

In another aspect, a control system for controlling a vehicle is provided. The control system includes a computer device including at least one memory and at least one processor in communication with the at least one memory, the at least one processor programmed to execute a first path planning methodology, using data received from a sensor, to determine if there is at least one kinematically feasible merge gap defined by at least one traffic vehicle. If the controller determines that there is at least one kinematically feasible merge gap, then the controller identifies a target merge gap that includes one of the at least one determined kinematically feasible merge gaps and determines a merge plan for merging with the target merge gap. If the controller determines that there is not at least one feasible merge gap, the controller compares sensor data to a switch criterion to determine if a second path planning methodology is required.

In a further aspect, a method for controlling a vehicle using a controller associated with the vehicle is provided. The method includes executing a first planning methodology, using data received from at least one sensor, to determine if there is at least one kinematically feasible merge gap defined by at least one traffic vehicle. If the controller determines that there is at least one kinematically feasible merge gap, then the controller identifies a target merge gap that includes one of the at least one determined kinematically feasible merge gaps and determines a merge plan for merging with the target merge gap. If the controller determines that there is not at least one feasible merge gap, the controller compares sensor data to a switch criterion to determine if a second planning methodology is required.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The FIGS. described below depict various aspects of the systems and methods disclosed therein. It should be understood that each FIG. depicts an exemplary embodiment of a particular aspect of the disclosed systems and methods, and that each of the FIGS. is intended to accord with a possible embodiment thereof. Further, wherever possible, the following description refers to the reference numerals included in the following FIGS., in which features depicted in multiple FIGS. are designated with consistent reference numerals.

There are shown in the drawings arrangements which are presently discussed, it being understood, however, that the present embodiments are not limited to the precise arrangements and are instrumentalities shown, wherein:

FIG. 1 illustrates a schematic diagram of an exemplary vehicle including a vehicle controller.

FIG. 2 illustrates a schematic diagram of an exemplary vehicle control system. including the vehicle controller shown in FIG. 1 and including a merge module for determining a merge plan for the vehicle.

FIG. 3 illustrates a schematic diagram of the vehicle shown in FIG. 1 traveling within an exemplary merge scenario.

FIG. 4 illustrates a schematic diagram of the vehicle shown in FIG. 1 traveling within another exemplary merge scenario.

FIG. 5 illustrates a schematic diagram of the vehicle shown in FIG. 1 traveling within another example merge scenario.

FIG. 6 illustrates a schematic diagram of the vehicle shown in FIG. 1 traveling within another exemplary merge scenario.

FIG. 7 illustrates a flowchart of an exemplary process that may be implemented by the vehicle controller to determine a merge plan for the vehicle shown in FIG. 1 to perform when approaching a merge scenario.

FIGS. 8A-C illustrate a flowchart of another exemplary process that may be implemented by the vehicle controller to determine a merge plan for the vehicle shown in FIG. 1 to perform when approaching a merge scenario.

FIG. 9 illustrates a flowchart of another exemplary process that may be implemented by the vehicle controller to determine a merge plan for the vehicle shown in FIG. 1 to perform when approaching a merge scenario.

FIG. 10 illustrates a schematic diagram of the vehicle shown in FIG. 1 traveling within another exemplary merge scenario.

FIG. 11 illustrates a schematic diagram of the vehicle shown in FIG. 1 traveling within another exemplary merge scenario.

FIG. 12 illustrates a schematic diagram of the vehicle shown in FIG. 1 traveling within another exemplary merge scenario.

FIG. 13 illustrates a schematic diagram of the vehicle shown in FIG. 1 traveling within another exemplary merge scenario.

FIG. 14 illustrates a schematic diagram of the vehicle shown in FIG. 1 traveling within another exemplary merge scenario.

FIG. 15 illustrates a schematic diagram of the vehicle shown in FIG. 1 traveling within another exemplary merge scenario.

FIG. 16 illustrates a schematic diagram of the vehicle shown in FIG. 1 traveling within another exemplary merge scenario.

FIG. 17 illustrates a schematic diagram of the vehicle shown in FIG. 1 traveling within another exemplary merge scenario.

FIG. 18 illustrates a schematic diagram of the vehicle shown in FIG. 1 traveling within another exemplary merge scenario.

FIG. 19 illustrates a schematic diagram of the vehicle shown in FIG. 1 traveling within another exemplary merge scenario.

FIG. 20 illustrates a schematic diagram of the vehicle shown in FIG. 1 traveling within another exemplary merge scenario.

FIG. 21 illustrates a schematic diagram of the vehicle shown in FIG. 1 traveling within another exemplary merge scenario.

FIG. 22 illustrates a schematic diagram of the vehicle shown in FIG. 1 traveling within another exemplary merge scenario.

FIG. 23A-D illustrates a schematic diagram of the vehicle shown in FIG. 1 traveling within exemplary example merge scenario.

FIG. 24 illustrates a schematic diagram of the vehicle shown in FIG. 1 traveling within another exemplary merge scenario.

FIG. 25 illustrates a schematic diagram of the vehicle shown in FIG. 1 traveling within another exemplary merge scenario.

FIG. 26 illustrates a schematic diagram of the vehicle shown in FIG. 1 traveling within another exemplary merge scenario.

The FIGS. depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the term “database” may refer to either a body of data, a relational database management system (RDBMS), or to both, and may include a collection of data including hierarchical databases, relational databases, flat file databases, object-relational databases, object oriented databases, and/or another structured collection of records or data that is stored in a computer system. The above examples are not intended to limit in any way the definition and/or meaning of the term database. Examples of RDBMS's include, but are not limited to, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

A computer program of one embodiment is embodied on a computer-readable medium. In an example, the system is executed on a single computer system, without requiring a connection to a server computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in different environments without compromising any major functionality. In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

As used herein, the terms “processor” and “computer” and related terms, e.g., “processing device,” “computer device,” and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random-access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable and include any computer program storage in memory for execution by personal computers, workstations, clients, servers, and respective processing elements thereof.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device, and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of: the time of occurrence of the associated events, the time of measurement and collection of predetermined data, the time for a computer device (e.g., a processor) to process the data, and/or the time of a system response to the events and the environment. In the embodiments described herein, these activities and events may be considered to occur substantially instantaneously.

The present embodiments may relate to, inter alia, systems and methods that may be implemented to control a vehicle travelling through an intersection based upon sensor data received in real-time. In an exemplary embodiment, the process is performed by a vehicle control system, also known as a vehicle controller.

In the exemplary embodiment, the vehicle includes a plurality of sensors that enable the vehicle to observe its immediate surroundings in real-time. The sensors can include, but are not limited to only including, radar, LIDAR, proximity sensors, ultrasonic sensors, electromagnetic sensors, wide RADAR, long distance RADAR, Global Positioning System (GPS), video devices, imaging devices, cameras, audio recorders, and computer vision. The vehicle controller receives sensor data from the sensors.

In one embodiment described herein, systems and methods for determining a merge plan, e.g., a merge trajectory, a merge speed, and/or a merge acceleration, are provided for a vehicle (e.g., host vehicle or ego vehicle) traveling along a merge lane. The vehicle includes a vehicle controller that is communicatively coupled to one or more sensors for detecting conditions associated with a merge scenario. The vehicle controller includes a merge module that includes a plurality of methodologies which may be executed by the vehicle controller to determine a merge plan. For example, the vehicle controller utilizes a methodology switching criterion to determine when, or if, to switch between the different methodologies based on the merge scenario, e.g., the traffic density, merge lane dimensions, length of remaining merge lane, number of traffic vehicles, and/or speeds of the traffic, etc. The switching between the different methodologies, herein after known as methodology switching, initiated after determining that the switching criterion is satisfied, may be executed in real-time and may be executed automatically as the vehicle is navigating a merge scenario. By determining which methodology to apply to determine the merge plan based on the merge scenario, the vehicle controller avoids continuously running multiple real-time simulations (i.e., avoids continuously applying multiple trajectory planning methodologies) and calculating suitability scores to determine which methodology to apply to the current merge situation.

In one embodiment, the merge module includes at least two different merge methodologies including a first planning methodology (e.g., a gap planning methodology) and a second planning methodology (e.g., a lattice planning methodology and/or any suitable searching). Generally, the first planning methodology is used by the vehicle controller to determine a merge plan for merge scenarios in which light traffic exists, and one or more suitable merge gaps are defined, or a long merging lane that provides space, and/or time, to use the first planning methodology to determine a merge plan. The second planning methodology is used by the vehicle controller to determine a merge plan for merge scenarios in which heavy traffic is present and/or there is a shorter merging lane.

The merge module may also include one or more additional methodologies to be executed by the vehicle controller in tandem with execution of the first planning methodology and/or the second planning methodology. For example, the merge module may include a third methodology (e.g., a negotiation methodology) that may be executed in connection, e.g., simultaneously, or subsequently, with the execution of the first planning methodology and/or the second planning methodology. Generally, the second planning methodology requires an increased computational load, e.g., times and processor capacity, as compared to the first planning methodology. However, the vehicle controller may determine, using the switch criterion, that certain merge scenarios require the use of the second planning methodology. As such, some embodiments described herein are computationally efficient, and enable the vehicle controller to use methodologies that use decreased computational loads for certain merge scenarios.

In some embodiments, a user/driver may store preferences that would let the vehicle controller know if there are any additional considerations that may affect the merge decision-making process. The vehicle controller may use these preferences as weighting in its decision-making process. In some embodiments, the user may directly enter their preferences. For example, the user/driver may want to minimize left turns across a lane designated for an opposed flow of traffic. In other embodiments, the vehicle controller learns these preferences over time based on the user's driving behavior. Other preferences may include regional or national preferences based on observations of the vehicle controller and/or a plurality of vehicle controllers.

At least one of the technical problems addressed by this system may include: (i) using the most computationally efficient merge methodology to conserve computational resources while determining a merge plan, (ii) determining, using a switching criterion, when a merge scenario requires the use of a more computationally-demanding methodology, e.g., the second planning methodology, for example, and (iii) determining if a merge scenario requires a third methodology.

The methods and systems described herein may be implemented using computer programming or engineering techniques including computer software, firmware, hardware, or any combination or subset thereof, wherein the technical effects may be achieved by performing at least one of the following: a) execute a first planning methodology, using data received from a sensor, to determine if there is at least one kinematically feasible merge gap defined by at least one traffic vehicle, b) if the controller determines that there is at least one kinematically feasible merge gap, then the controller identifies a target merge gap that includes one of the at least one determined kinematically feasible merge gaps, and determines a merge plan for merging with the target merge gap, c) if the controller determines that there is not at least one feasible merge gap, the controller compares sensor data to a switch criterion to determine if a second planning methodology is required. In some embodiments, if the controller determines that there is not at least one feasible merge gap and the controller determines that the switch criterion is not satisfied, the controller is further programmed to execute a negotiation methodology to negotiate with at least one traffic vehicle to generate a kinematically feasible merge gap.

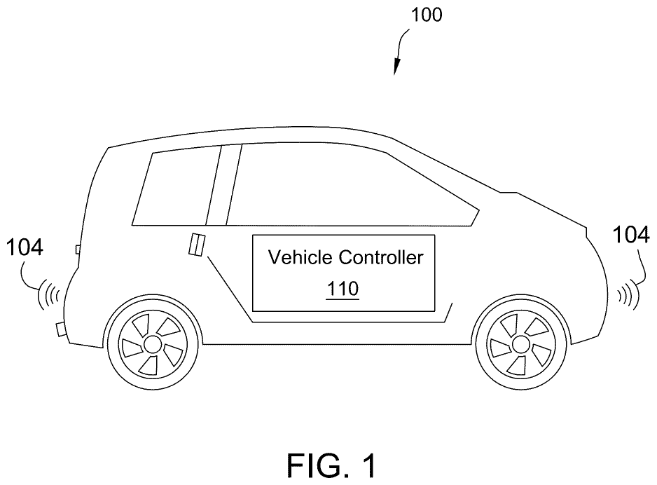

FIG. 1 depicts a view of an exemplary vehicle 100, e.g., a vehicle 100, tasked with executing a merge plan to enable the vehicle 100 to merge with traffic traveling along an adjacent lane. In some embodiments, the vehicle 100 may be an autonomous or semi-autonomous vehicle capable of fulfilling the transportation capabilities of a traditional automobile or other vehicle. In these embodiments, the vehicle 100 may be capable of sensing its environment and/or navigating through traffic intersections and traffic without human input. In other embodiments, the vehicle 100 is a manually-driven vehicle or a semi-autonomous vehicle that includes driver assistance systems, such as, but not limited to, lane-keep assistance, and/or parallel-parking assistance, wherein the vehicle may be driven as a traditional automobile that is controlled by a driver (not shown).

Vehicle 100 may include a plurality of sensors 104 and a vehicle controller 110. The sensors 104 may detect the current surroundings/environment and location of vehicle 100. The sensors 104 may include, but are not limited to only including, radar, LIDAR, proximity sensors, ultrasonic sensors, electromagnetic sensors, wide RADAR, long distance RADAR, Global Positioning System (GPS), video devices, imaging devices, cameras, audio recorders, and computer vision. The sensors 104 may also detect operating conditions of the vehicle 100, such as speed, acceleration, gear, braking, and/or other conditions related to the operation of vehicle 100, for example: at least one of a measurement of the speed, direction, rate of acceleration, rate of deceleration, location, position, orientation, and/or rotation of the vehicle, and a measurement of one or more changes to the speed, direction rate of acceleration, rate of deceleration, location, position, orientation, and/or rotation of the vehicle 100. Furthermore, sensors 104 may include impact sensors that detect impacts to the vehicle 100, including the force and direction, and/or the deployment of airbags. In some embodiments, sensors 104 may detect the presence of a driver and/or one or more passengers (not shown) in vehicle 100. In such embodiments, sensors 104 may detect the presence of fastened seatbelts, the weight occupying each seat in vehicle 100, heat signatures, and/or any other method of detecting information about the driver and/or passengers in vehicle 100.

In some embodiments, the sensors 104 may determine weight distribution information associated with the vehicle 100. Weight distribution information may include, but is not limited to only including, the weight and location of remaining gas, luggage, occupants, and/or other components of vehicle 100. In some embodiments, the sensors 104 may determine remaining gas, luggage weight, occupant body weight, and/or any other weight distribution information. Furthermore, the sensors 104 may detect attachments to the vehicle 100, such as cargo carriers or bicycle racks attached to the top of the vehicle 100 and/or a trailer attached to a hitch on the rear of the vehicle 100, for example.

In some embodiments, the sensors 104 detect and/or provide information about the immediate surroundings of the vehicle 100, such as, but not limited to, other vehicles including the type of vehicle and the vehicle load, any obstacles present, and traffic flow information including road signs, traffic lights, and other traffic information, and/or other environmental information, including current weather conditions.

Vehicle controller 110 may interpret the sensory information, obtained from sensors 104, to identify appropriate navigation paths through merge scenarios, to detect threats, and/or to react to conditions. In some embodiments, vehicle controller 110 may be able to communicate with one or more remote computer devices, such as a mobile device. In the example embodiment, the mobile device is associated with a driver and includes one or more internal sensors, such as an accelerometer, a gyroscope, and/or a compass. The mobile device may be capable of communicating with vehicle controller 110 wirelessly. In addition, vehicle controller 110 and the mobile device may communicate with devices located remotely from vehicle 100, such as but not limited to computer devices and/or a remote server.

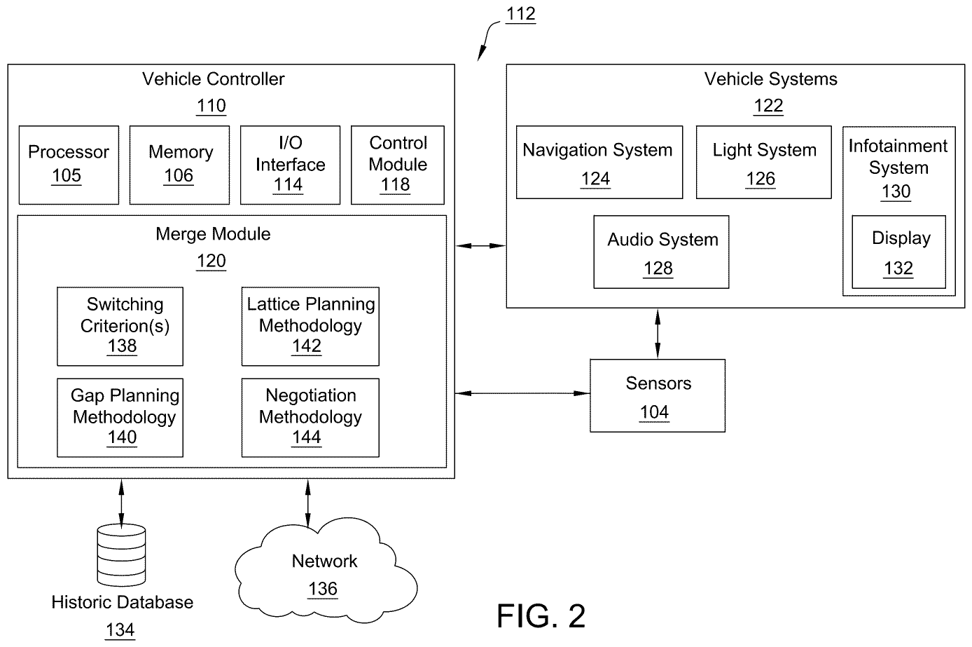

The vehicle controller 110 may receive user preferences input from the user through the mobile device or through an infotainment panel (shown in FIG. 2). The vehicle controller 110 may also receive preferences input via one or more remote servers. These remote servers may be associated with the vehicle manufacturer or other service providers that provide preference information. The remote servers may also provide traffic information including, but not limited to, travel routes, maps, traffic light timing, and/or current traffic load in areas in proximity to the vehicle 100.

In the exemplary embodiment, the vehicle controller 110 is an integrated advanced driver-assistance system (ADAS) that in some embodiments, includes autonomous or semi-autonomous vehicle-related functionality or technology that may be used to replace human driver actions. Such actions may include, but are not limited to only including, and/or be related to the following types of functionality: (a) fully autonomous (driverless); (b) limited driver control; (c) vehicle-to-vehicle (V2V) wireless communication; (d) vehicle-to-infrastructure (and/or vice versa) wireless communication; (e) automatic or semi-automatic steering; (f) automatic or semi-automatic acceleration; (g) automatic or semi-automatic braking; (h) automatic or semi-automatic blind spot monitoring; (i) automatic or semi-automatic collision warning; (j) adaptive cruise control; (k) automatic or semi-automatic parking/parking assistance; (l) automatic or semi-automatic collision preparation (windows roll up, seat adjusts upright, brakes pre-charge, etc.); (m) driver acuity/alertness monitoring; (n) pedestrian detection; (o) autonomous or semi-autonomous backup systems; (p) road mapping systems; (q) software security and anti-hacking measures; (r) theft prevention/automatic return; and/or(s) automatic or semi-automatic driving without occupants; and/or other functionality. In these embodiments, the autonomous or semi-autonomous vehicle-related functionality or technology may be controlled, operated, and/or in communication with vehicle controller.

The wireless communication-based autonomous or semi-autonomous vehicle technology or functionality may also include and/or be related to: automatic or semi-automatic steering; automatic or semi-automatic acceleration and/or braking; automatic or semi-automatic blind spot monitoring; automatic or semi-automatic collision warning; adaptive cruise control; and/or automatic or semi-automatic parking assistance. Additionally, or alternatively, the autonomous or semi-autonomous technology or functionality may also include and/or be related to: driver alertness or responsive monitoring; pedestrian detection; artificial intelligence and/or back-up systems; hazard avoidance; navigation or GPS-related systems; security and/or anti-hacking measures; and/or theft prevention systems.

Although vehicle 100 is illustrated as being an automobile in the exemplary embodiment, in other embodiments, vehicle 100 may be, but is not limited to, other types of ground craft including buses, cargo-carriers, or trucks, aircraft, a self-driving, electric micro-mobility vehicle (e.g., Cooperative Intelligent KOMA (Koma means a pony in Japanese, (CiKoMa) system), watercraft, and/or spacecraft vehicles.

FIG. 2 is a schematic diagram of an exemplary vehicle control system 112 including a merge module 120 that may be used to determine a merge plan for the vehicle 100 traveling in a merge scenario, e.g., the vehicle 100 may be traveling along a merge lane and the merge plan may be executed by the vehicle 100 to cause the vehicle 100 to merge with one or more traffic vehicles traveling in the same direction within an adjacent lane. As described in further detail herein, a merge plan includes one or more of the following: a target merge gap or potential merge gap(s), a merge trajectory (e.g., a merge path), a speed and/or an acceleration/deceleration on the merge trajectory, time to reach a target merge gap, a rate of change of acceleration/deceleration (e.g., jerk), and/or vehicle orientation and path curvature.

The components of the vehicle control system 112 may be implemented with or may be associated with the vehicle 100 and the vehicle controller 110 (shown in FIG. 1). The vehicle controller 110 includes components enabled for processing, communicating, and interacting with various components of the vehicle 100 and other components of the vehicle control system 112. In one embodiment, the vehicle controller 110 can be implemented with the exemplary vehicle 100 (FIG. 1), such as, for example, as part of a telematics unit, a head unit, a navigation unit, an infotainment unit, an electronic control unit, among others. In other embodiments, the components, and functions of the vehicle controller 110 can be implemented remotely from the exemplary vehicle 100. For example, the vehicle controller 110 may be associated with a portable device (not shown) such as a laptop, tablet, or cellular device, or another computing device connected via a network (e.g., a network 136).

In the exemplary embodiment, the vehicle controller 110 includes a processor 105, a memory 106, and an input/output (I/O) interface 114, which are each operably connected for computer communication via a bus, not shown, and/or other wired and wireless technologies. The I/O interface 114 provides software and hardware to facilitate data input and output between the components of the vehicle controller 110 and other components, networks, and data sources. The vehicle controller 110 also includes a control module 118 and a merge module 120, for assisting a vehicle 100 in determining a merge plan and executing a merge plan. For example, after the merge module 120 determines a merge plan for the vehicle 100 to merge with traffic of the adjacent lane, the control module 118 transmits one or more control signals to one or more vehicle systems 122, causing the vehicle systems 122 to execute the merge plan, e.g., perform steering, breaking, or accelerating/decelerating operations, e.g., using a navigation system 124.

The vehicle controller 110 may be operably connected for computer communication (e.g., the I/O interface 114) to one or more vehicle systems 122. The vehicle systems 122 can include, but are not limited to, any automatic or manual systems that can be used to enhance the vehicle, driving, and/or safety. The vehicle systems 122 include the navigation system 124, a light system 126, an audio system 128, an infotainment system 130 including a display 132, and/or any other suitable vehicle component enabling the systems and methods described herein to determine a merge plan and execute the determined merge plan. The navigation system 124 stores, calculates, and provides route and destination information and facilitates features like turn-by-turn directions, e.g., separate from or in tandem with the determined merge plan. The light system 126 controls the lights of the vehicle to actuate, including, for example, interior lights such as the dashboard lights and/or exterior lights, such as lights mounted on the side view mirrors of the exemplary vehicle 100. The audio system 128 controls audio (e.g., audio content, volume) in the exemplary vehicle 100. The infotainment system 130 provides visual information and/or entertainment and the display 132 may display the merge plan to the vehicle operator, for example.

The vehicle systems 122 include and/or are communicatively connected to the various vehicle sensors 104. The vehicle sensors 104 collect data associated with the vehicle, the vehicle's environment, and/or the vehicle's systems 122. The vehicle sensors 104 are described above with respect to FIG. 1.

The vehicle controller 110 is also communicatively coupled to a network 136 and a historic database 134. For example, communications may be facilitated through a network connection (e.g., wired, or wireless), a cellular data network from a portable device (not shown), a vehicle-to-vehicle network (not shown), an in-vehicle network (not shown), among others, or any combination of thereof. In some embodiments, the historic database 134 may be associated with or connected to the memory 106.

The network 136 may include a data network, the Internet, a wide area network or a local area network, for example. The network 136 serves as a communication medium to various remote devices (e.g., databases, web servers, remote servers, application servers, intermediary servers, client machines, and/or other portable devices). In some embodiments, the historic database 134 may be included in the network 136, accessed by the vehicle controller 110 through the network 136, and/or the network 136 can access the historic database 134. Thus, in some embodiments, the vehicle controller 110 can obtain data from the historic database 134 via the network 136.

As will be described in further detail herein, the vehicle controller 110, and in particular the merge module 120, uses sensor data received from vehicle sensors 104 to determine a merge plan to be executed by the vehicle systems 122 during a merge scenario. In embodiments described herein, the vehicle controller 110 and/or the merge module 120 determines the merge plan by executing one or more of a plurality of methodologies. The plurality of methodologies may be stored in the memory 106 and/or in the merge module 120, and the merge module 120 selects a suitable methodology based on, at least in part, by comparing sensor data to methodology switching criterion(s) 138. For example, the vehicle controller 110 may compare one or more methodology switching criterion(s) 138 to sensor data in order to select a suitable methodology. For example, the methodology switching criterion 138 may be used by the merge module 120 to switch between the different methodologies based on the merge scenario, e.g., the traffic density and/or speeds of the traffic. The methodology switching, initiated by determining whether the criterion is satisfied, may be executed in real-time and automatically as the vehicle 100 is navigating a merge scenario.

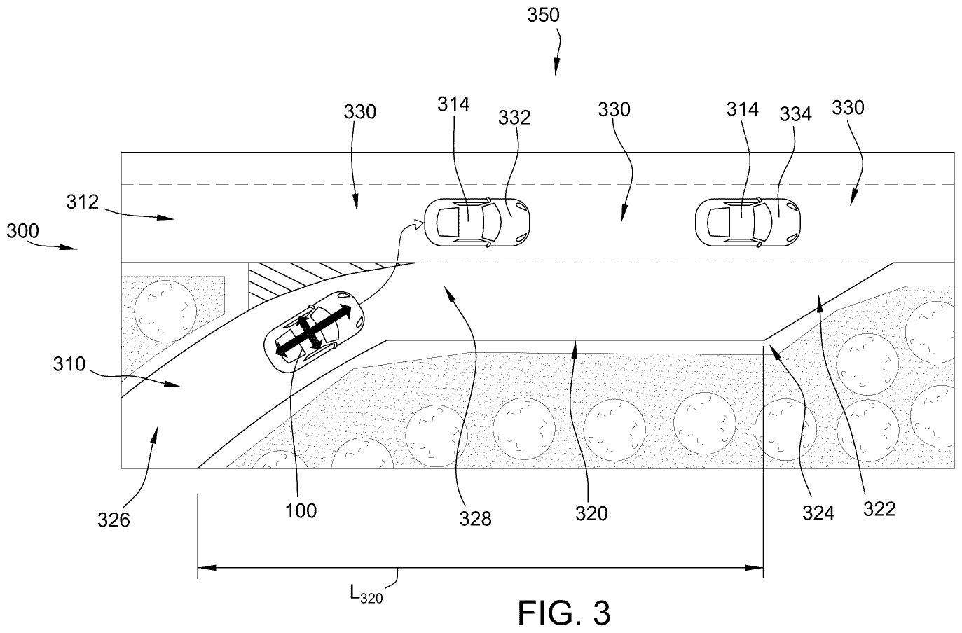

Each of the plurality of methodologies may be best suited for use in determining a merge plan for a type of merge scenario. Merge scenarios may generally include merging into light or congested traffic, or merging along a shortened or longer merge lane, for example. Various examples of merge scenarios are described in further detail with respect to FIGS. 3-6 and 11-28. In the embodiments described herein, the merge module 120 includes at least two methodologies stored therein which may be executed by the vehicle computing device, e.g., the merge module 120 or processor 105, to determine a merge plan. For example, the two methodologies may include a first planning methodology 140 (e.g., a gap planning methodology) and a second planning methodology 142 (e.g., a lattice planning methodology). Generally, the first planning methodology 140 is suitable for determining a merge plan for merge scenarios in which there is light traffic having one or more suitable merge gaps, or for merge scenarios wherein a longer merging lane provides space, and time, to use the first planning methodology 140 to determine a merge plan. The second planning methodology 142 is suitable for determining a merge plan for merge scenarios in which there is heavy traffic, or scenarios wherein there is a shorter merging lane or a shorter remaining merge lane length. The merge module 120 may also include one or more additional methodologies, executed by the vehicle controller 110 in tandem with execution of the first planning methodology 140 and/or the second planning methodology 142. For example, the merge module 120 may include a third methodology 144, (e.g., a negotiation methodology which may be executed during executing of the first planning methodology 140), e.g., prior to the methodology switching criterion 138 being satisfied.

In the exemplary embodiment, the vehicle controller 110 controls one or more aspects of the operation of a vehicle 100. A user's vehicle controller 110 may be communicatively coupled through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and/or a cable modem.

In other embodiments, the vehicle is in communication with an infrastructure device, not shown, to receive traffic information in real-time or near real-time. In further embodiments, the infrastructure device may provide images from one or more cameras at a merge lane. In still further embodiments, the infrastructure device may wirelessly broadcast information to all vehicles in the nearby area, such as through Wi-Fi, Bluetooth, and/or ZigBee communications. In some embodiments, the infrastructure device can also include a mapping program server or other program to assist with navigating the vehicle 100. In yet other embodiments, the infrastructure device is in communication with emergency vehicles in the area to enable the vehicle 100 to choose a course of action that provides space to the emergency vehicles to enable the vehicles to pass the vehicle 100 safely, for example.

A database server, not shown, may be communicatively coupled to a database that stores data. In the exemplary embodiment, the database may be stored internally within and/or may be stored remotely from the vehicle controller 110. In some embodiments, the database may be decentralized. In some embodiments, the database may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem.

In some embodiments, the vehicle controller 110 may present information to a user via any component capable of conveying information to the user, including the infotainment system 130. In some embodiments, the vehicle controller 110 may also be in communication with an output adapter (not shown) such as a video adapter and/or an audio adapter. An output adapter may be operatively coupled to vehicle controller 110 and/or to an output device such as a display device (e.g., a cathode ray tube (CRT), liquid crystal display (LCD), light emitting diode (LED) display, or “electronic ink” display) or an audio output device (e.g., a speaker or headphones). In some embodiments, the vehicle controller 110 may be present a graphical user interface (e.g., a web browser and/or a client application) to the user, such as through the infotainment system 130. A graphical user interface (GUI) may include, for example, route information. In some embodiments, the user may enter information into the vehicle controller 110 using an input device, such as, without limitation, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component and input device.

The processor 105 within the vehicle controller 110 executes computer-executable instructions for implementing aspects of the disclosure. In some embodiments, the processor 105 is transformed into a special purpose microprocessor by executing computer-executable instructions or by otherwise being programmed. For example, the processor 105 may be programmed with instructions. The processor 105 may also be operatively coupled to a storage device. The storage device may be any computer-operated hardware suitable for storing and/or retrieving data, such as, but not limited to, data associated with the database. In some embodiments, the storage device is integrated in a server computer device. For example, the server computer device may include one or more hard disk drives as storage device. In other embodiments, the storage device is external to the vehicle 100.

FIGS. 3-6 illustrate schematic diagrams of exemplary merge scenarios 350, 360, 370, and 380 for the vehicle 100 traveling along a merge lane 310 positioned adjacent to an adjacent traffic lane 312 on which one or more traffic vehicles 314 may be traveling. In some merge scenarios, the merge lane 310 may include various features or dimensions generally referred to herein as merge lane parameters, such as an adjacent lane portion 320 and a tapered portion 322 located at an end 324 of the adjacent lane portion 320. In some embodiments, the adjacent lane portion 320 includes a curved portion 326 and a straight portion 328. The adjacent lane portion 320 has a length L₃₂₀, e.g., a length of the adjacent lane portion 320 and/or a length that includes the curved portion 326 and the straight portion 328. The merge lane 310 may include additional or alternative features. For example, and without limitation, the merge lane 310 may include a hard and/or a soft nose position, a merge nose length, a merge taper length, a number of adjacent traffic lanes 312 (e.g., merging onto a single lane highway or a two-lane highway), and the like. The merge lane 310 may also include additional and/or alternative merge lane 310 parameters.

One or more of the traffic vehicles 314 traveling within lane 312 may be spaced such that at least in part a gap 330, e.g., a potentially kinematically feasible merge gap, as described below, is defined within lane 312. The gap 330 may be defined between a lead vehicle 334 and a following vehicle 332, e.g., between a rear end of the lead vehicle 332 and a front end of the following vehicle 334. The gap 330 may also be defined by only one traffic vehicle 314, e.g., the front end or the rear end of a single traffic vehicle 314. The gaps 330 may each include a gap length. The gap length may change over time, e.g., if one or more of the traffic vehicles 314 accelerates or decelerates, or if a traffic vehicle 314 changes into a different traffic lane 312, for example.

In reference to the merge scenarios shown in FIGS. 3-6, the merge module 120 may execute the first planning methodology 140 to determine the merge path if for example, the methodology switching criterion 138 has not been satisfied.

FIG. 3 shows an exemplary merge scenario 350 wherein the vehicle 100 is merging with light, free-flowing traffic vehicles 314 defining one or more potential merge gaps 330. The vehicle controller 110 within the vehicle 100 may execute the first planning methodology 140, at least initially at the beginning of the merge lane 310, to determine if there is at least one kinematically feasible merge gap, e.g., gaps 330 having a suitable length and/or position relative to the vehicle 100, such that it is kinematically feasible for the vehicle 100 to merge into the adjacent traffic lane 312. If the vehicle controller 110 determines that there is a plurality of kinematically feasible merge gaps, then the vehicle controller 110 selects a target merge gap from the plurality of kinematically feasible merge gaps.

In some embodiments, the vehicle controller 110 may determine a merge efficiency for each of the plurality of kinematically feasible merge gaps. In some embodiments, a higher merge efficiency may be associated with a lower velocity or a lower acceleration required by the vehicle 100 to merge into the merge gap. In some embodiments, a higher merge efficiency may be associated with a reduced merge travel distance. In some embodiments, a higher merge efficiency is associated with a longer merge gap length. The vehicle controller 110 may compare the merge efficiencies to select a target merge gap, e.g., the merge gap having the highest efficiency.

After the vehicle controller 110 and/or the merge module 120 determines a target merge gap the vehicle controller 110 determines a merge plan for the vehicle 100, and the vehicle controller 110 causes the vehicle 100 to execute the merge plan causing the vehicle 100 to merge into the target merge gap. For example, in the merge scenario 360, the vehicle controller 110 determines a target merge gap including a larger merge gap 330 behind the last traffic vehicle 314, using the first planning methodology 140, and the vehicle 100 then modulates, e.g., decelerates or accelerates in some scenarios, to execute the merge plan. In some embodiments, the vehicle controller 110 may continue to execute or re-execute the first planning methodology 140 to identify kinematically feasible merge gaps and/or to confirm that the target merge gap is still kinematically feasible.

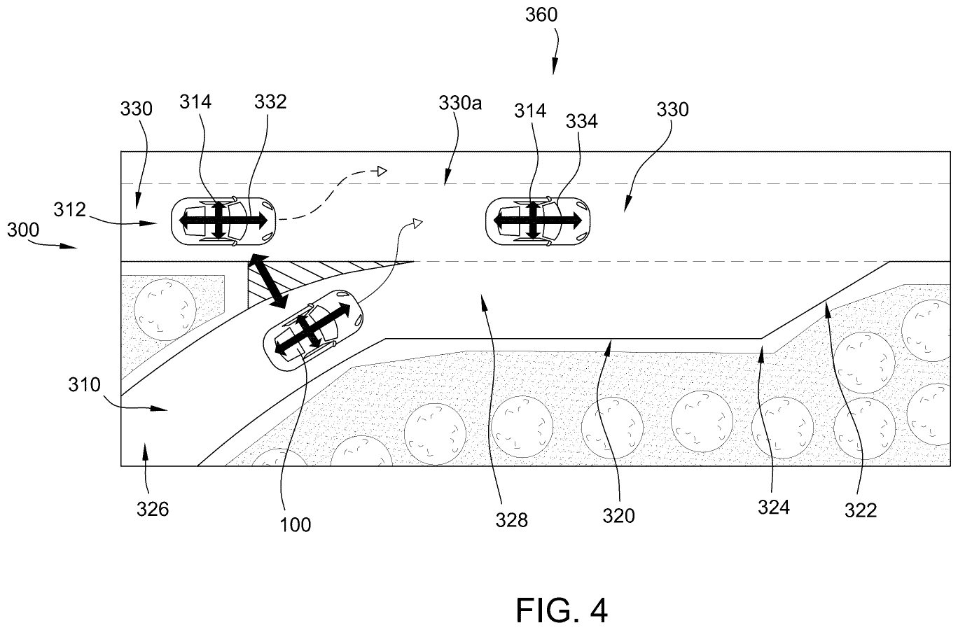

In another exemplary merge scenario 360, shown in FIG. 4, the vehicle 100 is merging with light, free-flowing traffic vehicles 314 defining a plurality of gaps 330. The gap 330a defined between the two traffic vehicles 314, shown in FIG. 4, may be a potential merge gap, but it's determined that the potential merge gap does not have a sufficient merge length, at least initially, before the vehicle 100 reaches or approaches the end 324 or the tapered portion 322 of the merge lane 310. In this merge scenario 360, the potential merge gap 330a may have a length that is close to a merge gap length, e.g., the potential merge gap is slightly less than a merge gap length, such that the potential merge gap length is not quite kinematically feasible. The vehicle controller 110 may initially execute the first planning methodology 140, to identify the potential merge gap 330a, then the vehicle controller 110 may execute the third methodology 144. The third methodology 144 causes the vehicle 100 to perform one or more negotiation maneuvers, e.g., accelerating or decelerating to align with a potential merge gap, and/or traffic signaling. Generally, the negotiation maneuvers indicate to one or more of the traffic vehicles 314 that the vehicle 100 intends to merge into a particular target merge gap. In the merge scenario 360, the traffic vehicles 314, responsive to the negotiation maneuvers of the vehicle 100, performs one or more responsive negotiation maneuvers, e.g., decelerating or switching lanes, to create a kinematically feasible merge gap, e.g., increasing the length of the potential merge gap 330a, such that the potential merge gap 330a becomes a kinematically feasible merge gap, e.g., has a suitable gap length thereby allowing the vehicle 100 to merge into traffic. In this merge scenario 360, the vehicle controller 110 may also determine that the vehicle 100 needs to accelerate/decelerate in order to merge with the kinematically feasible merge gap. In some embodiments, vehicle 314 does not respond, react, and/or responds in an adversarial manner to vehicle 100 during a merge scenario. As such, negotiation may not be feasible or successful. If vehicle 100 determines that negotiation is unsuccessful and/or the switching criterion has been met, then the vehicle may execute the second planning methodology. In the merge scenario 360, the vehicle controller 110 may determine if a switching criterion 138 is satisfied to determine if a different methodology is needed to identify a target merge gap. For example, after the vehicle controller 110 determines that there is currently not a kinematically feasible merge gap, the vehicle controller 110 may proceed to determine if another methodology is better suited or necessary. For example, the vehicle controller 110 may determine if the second planning methodology 142 is required by comparing sensor data to one or more switching criterion 138. The switching criterion 138 may be associated with one or more of the following, for example and without limitation, a length of remaining merge lane length, a normalized distance traveled on the merge lane 310, merge lane geometry, number of traffic vehicles 314, speed(s) of traffic vehicles 314, gap(s) 330 distances, or traffic density. In the merge scenario 360, the vehicle controller 110 determines that the switching criterion 138 is not satisfied, e.g., there is sufficient merge lane 310 remaining or the traffic is light enough, such that the second planning methodology 142 is not needed, at least not yet, and the vehicle controller 110 may continue to execute or re-execute the less computationally demanding first planning methodology 140 and/or the third methodology 144.

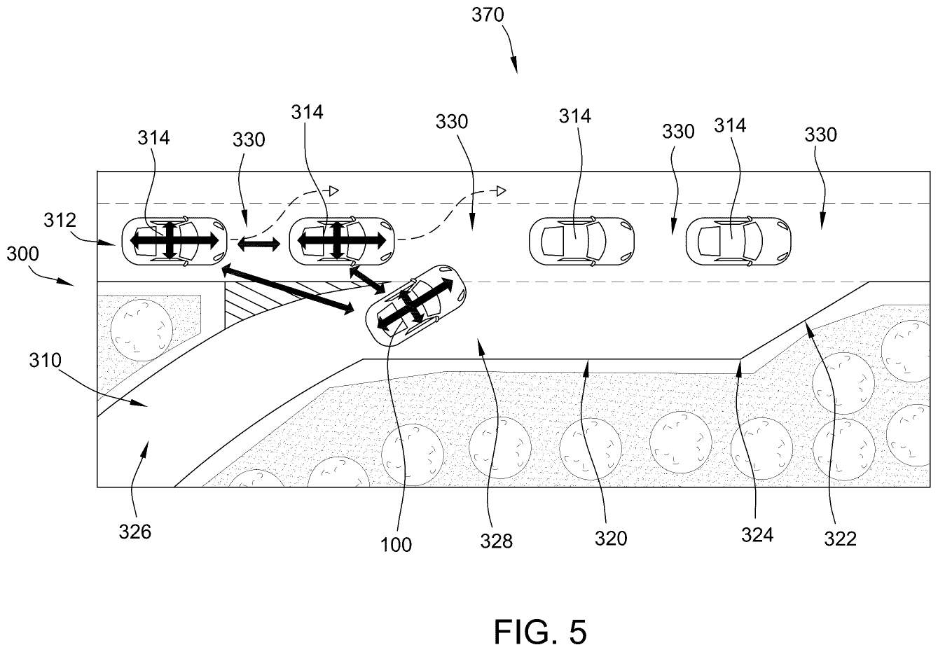

In another merge scenario 370 shown in FIG. 5, the vehicle 100 is merging into heavier traffic, e.g., during rush-hour, where the traffic vehicles 314 are traveling at a slower speed as compared to traffic speeds during light or free-flowing traffic and/or the traffic vehicles 314 are traveling in a denser pattern, e.g., closer together. The vehicle controller 110 may execute the first planning methodology 140 and determine that there is not a kinematically feasible merge gap. Subsequently, or simultaneously, the vehicle controller 110 may determine that the switching criterion 138 is not satisfied, and the vehicle controller 110 continues to execute the first planning methodology 140 and the third methodology 144 to merge with the traffic vehicles 314. The vehicle controller 110 may continuously, or periodically, determine if the switching criterion 138 is satisfied.

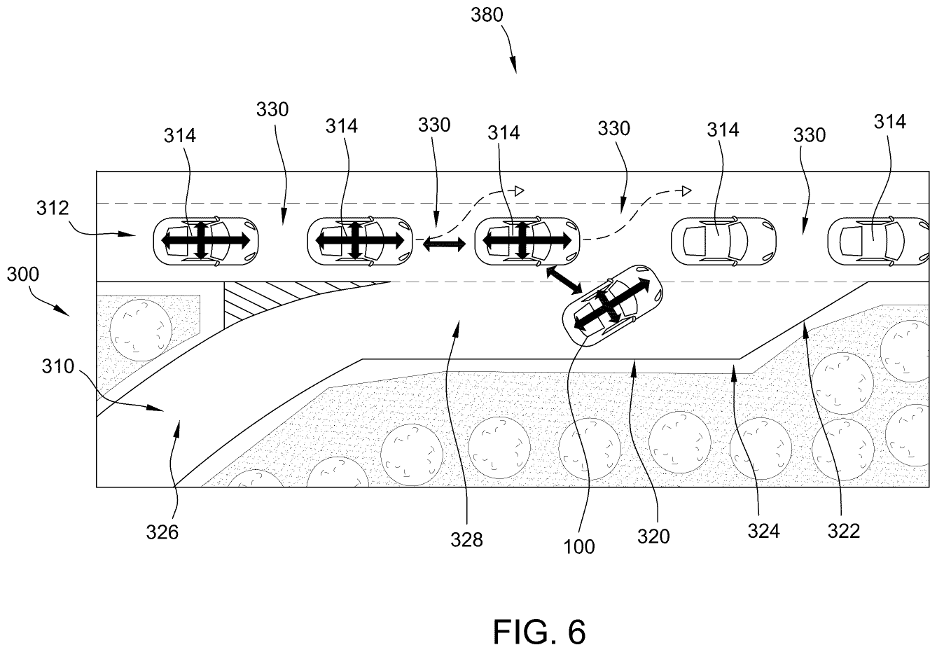

In another merge scenario 380 shown in FIG. 6, the vehicle 100 is merging into heavier traffic, e.g., during rush-hour, where the traffic vehicles 314 are traveling at a slower speed as compared to traffic speeds during light or free-flowing traffic and/or the traffic vehicles 314 are traveling closer together. In merge scenario 380, the first planning methodology 140 and/or the third methodology 144, and/or the second planning methodology 142 did not find a target merge gap, and the vehicle controller 110 determines that the vehicle 100 needs to decelerate or come to a stop, to wait for a kinematically feasible merge gap. The vehicle controller 110 continues to execute at least one of the first planning methodology 140, the third methodology 144, or the second planning methodology 142 until a kinematically feasible merge gap is created or found. In some embodiments, third methodology 144 includes negotiation with a lag vehicle (e.g., the available vehicle 314 in the lane 312 that is just behind the vehicle 100), however, the third methodology 144 includes evaluation of all gaps 330 (e.g., within the field of view of vehicle 100) and if another gap 330 seems feasible, or more feasible, the vehicle 100 may negotiate with another or different vehicle 314.

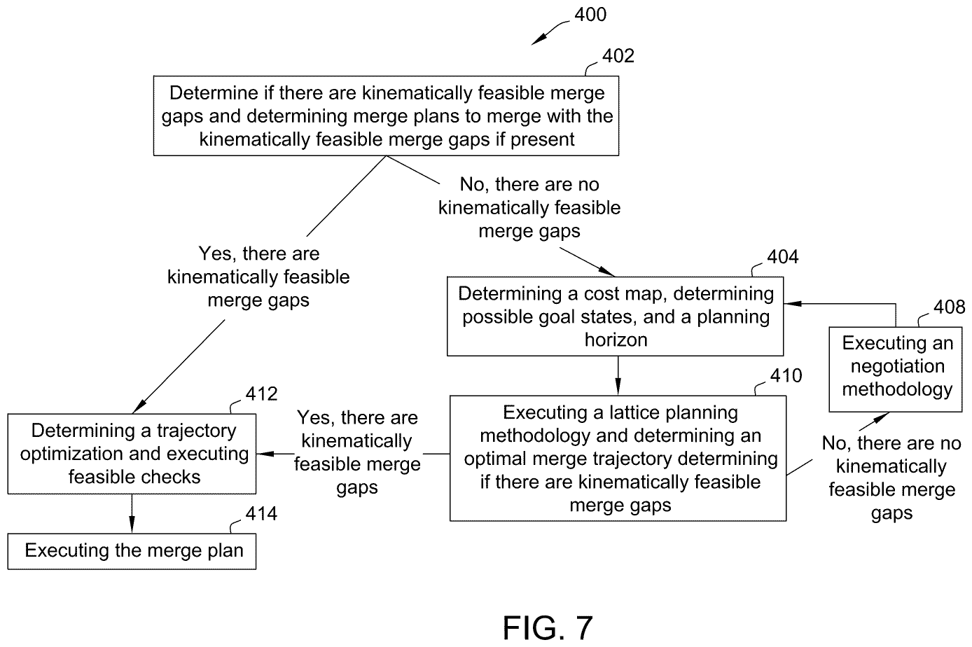

FIG. 7 shows an exemplary process 400 for determining a merge plan for a vehicle 100, e.g., vehicle 100, for merging during a merge scenario. The process 400 may be performed by a computing device, e.g., the vehicle controller 110. The process 400 includes determining 402 if there are one or more kinematically feasible merge gaps and/or determining merge plans including a trajectory for reaching, or merging, with the kinematically feasible merge gaps if they are found to be present. If the vehicle controller 110 determines 402 that there is no kinematically feasible gaps, the vehicle controller 110 then determines 404 a cost map, and determines 404 possible goal states, and/or a planning horizon. The process 400 may include executing 410 a second planning methodology 142 and determining an optimal merging trajectory and determining if there is a kinematically feasible merge gap. If there are still no kinematically feasible merge gap, the process 400 includes executing 408 the third methodology 144 in order to posture the vehicle 100, relative to the traffic, thus causing the traffic vehicles 314 to respond, e.g., accelerate or decelerate or change lanes, in order to create a kinematically feasible merge gap. If after executing the third methodology 144 there is still no feasible merge gap, the process 400 includes determining 404, e.g., again, a cost map, determining 404 possible goal states, and/or a planning horizon. In some embodiments, the process 400 includes iteratively determining 404, executing 408, and re-executing 410, until a kinematically feasible merge gap is created.

After it is determined 402 that there is a kinematically feasible merge gap the process 400 includes determining 412 a trajectory optimization and executing feasibility checks. In some embodiments, the vehicle controller 110 may execute 410, iteratively. Process 400 includes at least one of transmitting or executing 414 the merge plan, including a merge trajectory, causing the vehicle 100 to merge with the target merge gap (e.g., the identified kinematically feasible merge gap selected for merging). In the process 400, there is no evaluation or comparison of sensor data to a switching methodology criterion, e.g., after it has been determined 402 that there is no feasible merge gap, the process 400 proceeds with determining 404, executing 408, re-executing 410, until there is a feasible merge gap.

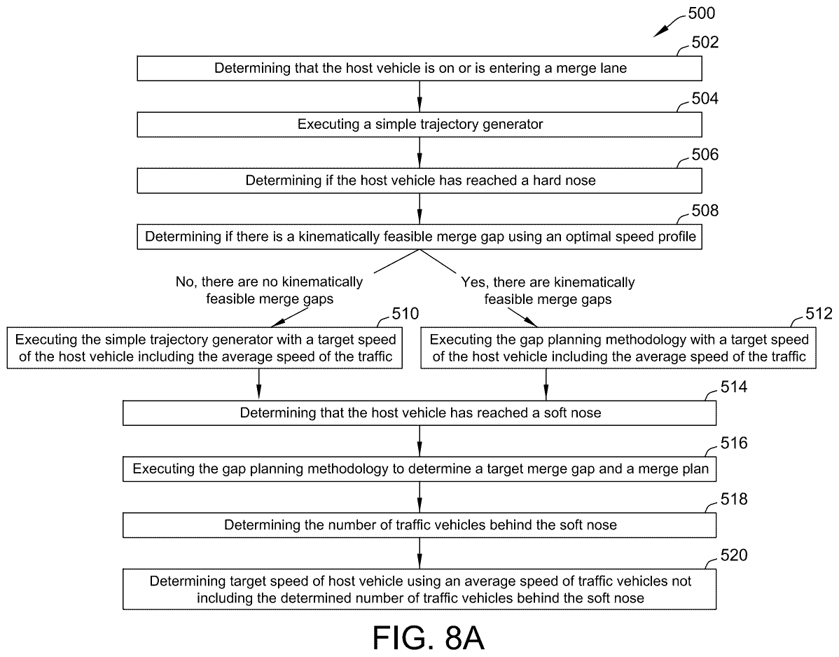

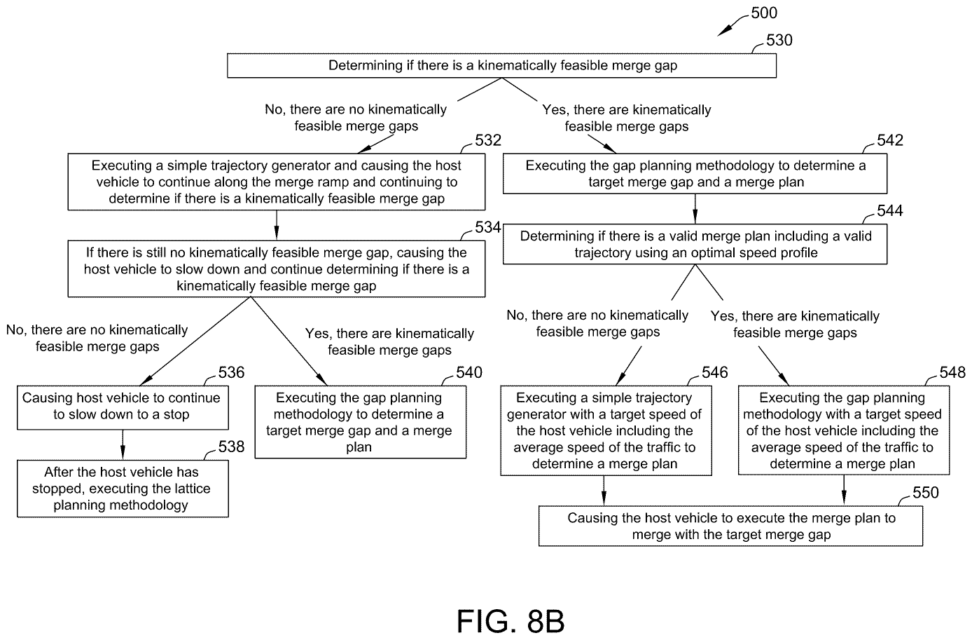

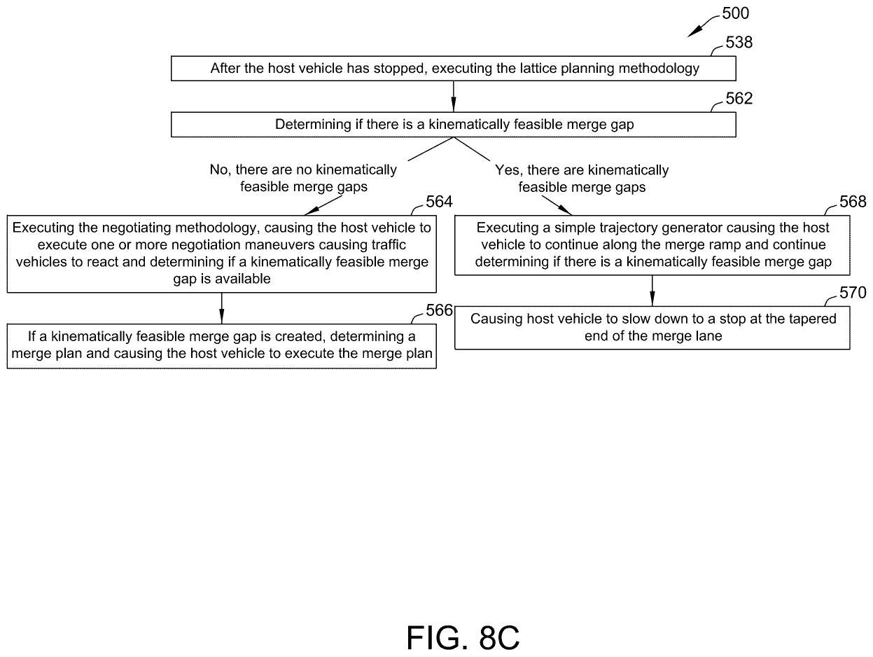

FIGS. 8A-8C shows another exemplary process 500 for determining a merge plan for a vehicle 100, e.g., vehicle 100, for merging during a merge scenario. The process 500 may be performed by a computing device, e.g., the vehicle controller 110. The process 500 includes, initially, determining 502 that the vehicle 100 is on, or is entering, a merge lane 310. The process 500 includes executing 504 a simple trajectory generator and determining 506 if the vehicle 100 has reached a hard nose. The process 500 includes determining 506 if there is a kinematically feasible merge gap using an optimal speed profile methodology. If there is a kinematically feasible merge gap, the process includes executing 512 the first planning methodology 140 with a target speed of the vehicle 100 including the average speed of the traffic. If there is not a kinematically feasible merge gap, the process 500 includes executing 510 a simple trajectory generator with a target speed of the vehicle 100 including the average speed of the traffic. The process includes determining 514 that the vehicle 100 has reached a soft nose and executing 516 the first planning methodology 140 to determine a target merge gap and a merge plan. The process 500 includes determining 518 the number of traffic vehicles 314 behind the soft nose and determining 520 a target speed of vehicle 100 using an average speed of traffic vehicles 314, not including the determined number of traffic vehicles 314 behind the soft nose.

In reference to FIG. 8B, the process 500 includes determining 530, again, if there is a kinematically feasible merge gap. If there are no kinematically feasible merge gaps, process 500 includes the vehicle controller 110 executing 532 a simple trajectory generator and causing the vehicle 100 to continue along the merge ramp and continuing to determine if there is a kinematically feasible merge gap. If there is still no kinematically feasible merge gap, the process 500 includes causing 534 the vehicle 100 to slow down and continue determining if there is a kinematically feasible merge gap. If there is still no kinematically feasible merge gap, the process 500 includes causing 536 vehicle 100 to slow down to a stop. After the vehicle 100 has stopped, the process 500 includes executing 538 the second planning methodology 142. If there is a kinematically feasible merge gap, the process includes executing 540 the first planning methodology 140 to determine a target merge gap and a merge plan.

If it was determined 530 that a kinematically feasible merge gap exists, then the process 500 includes executing 542 the first planning methodology 140 to determine a target merge gap and a merge plan and determining 544 if there is a valid merge plan including a valid trajectory using an optimal speed profile. If there is a valid merge plan, then the process 500 may include executing 546 a simple trajectory generator with a target speed of the vehicle 100 including the average speed of the traffic to determine a merge plan. If there is a valid merge plan, then the process 500 includes executing 548 the first planning methodology 140 with a target speed of the vehicle 100 including the average speed of the traffic to determine a merge plan. Process 500 includes causing 550 the vehicle 100 to execute the merge plan to merge with the target merge gap.

In reference to FIG. 8C, after the vehicle 100 has stopped and the second planning methodology 142 is executed 538, the process 500 includes determining 562, again, if there is a kinematically feasible merge gap. If there are no kinematically feasible merge gaps, then process 500 includes executing 564 the third methodology 144, causing the vehicle 100 to execute one or more negotiation maneuvers and causing traffic vehicles 314 to react and determine if a kinematically feasible merge gap is available. If there is a kinematically feasible merge gap, then the process 500 further includes determining 556 a merge plan and causing the vehicle 100 to execute the merge plan.

If the vehicle controller 110 determines 558 that there is a kinematically feasible merge gap, then process 500 includes executing 568 a simple trajectory generator causing the vehicle 100 to continue along the merge ramp and continue determining if there is a kinematically feasible merge gap (e.g., confirming that there is still a kinematically feasible merge gap). The process 500 includes causing 570 the vehicle 100 to slow down to a stop at the tapered portion 322 and/or end 324 of the merge lane 310 if the vehicle 100 has not completed the merge by the end of the merge lane 310.

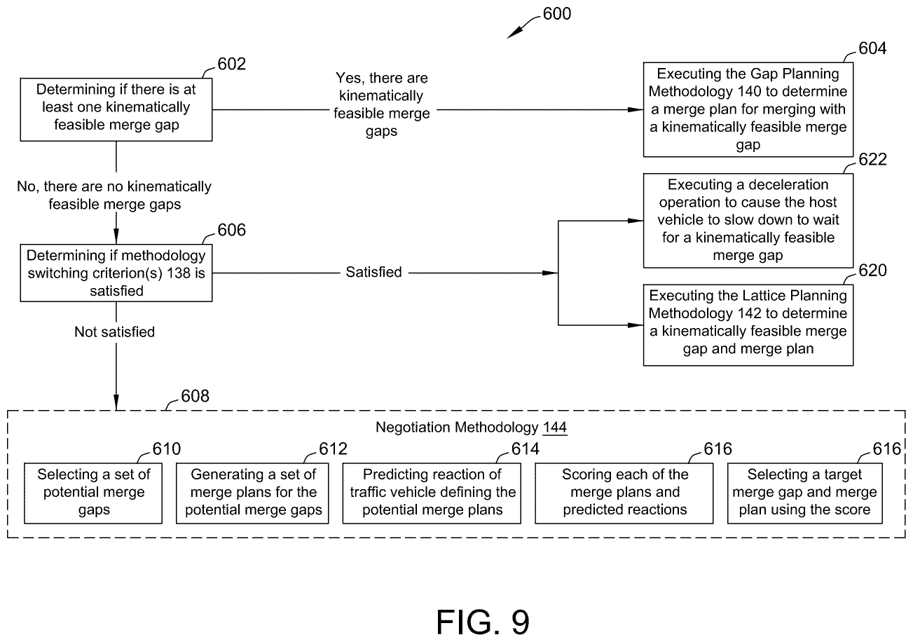

FIG. 9 shows an exemplary process 600 for determining a merge plan for a vehicle, e.g., vehicle 100, during a merge scenario. Any or all of process 600 may be performed by a computing device, e.g., the vehicle controller 110. The process 600 includes determining 602 if there is at least one kinematically feasible merge gap. If there is at least one kinematically feasible merge gap, the process 600 includes executing 604 the first planning methodology 140 to select a target merge gap, e.g., from the at least one determined kinematically feasible merge gap and to determine a merge plan. If there is no kinematically feasible merge gap, the process 600 includes determining 606 if a methodology switching criterion 138 is satisfied. Determining 606 may include the vehicle controller 110 comparing the switching criterion 138 to received sensor data. For example, the switching criterion 138 may be associated with one or more of the following parameters: traffic density, normalized distance traveled on the merge lane 310, merge lane geometry, and/or any other suitable data or merge lane parameters and/or combinations thereof. In some embodiments, the methodology switching criterion 138 may be include a function of weighted parameters, e.g., traffic density, normalized distance traveled on the merge lane 310, and merge lane geometry. If the criterion is not satisfied, the process 600 includes executing 608 the third methodology 144.

Execution 608 of the third methodology 144 includes the vehicle controller 110 selecting 610 a set of potential merge gaps, generating 612 a trajectory for each of the potential merge gaps, predicting 614 a reaction of a traffic vehicle at least partially defining the potential merge gap, scoring 616 each of the trajectories and/or the reactions. Executing 608 further includes selecting 618 an optimal merge gap and merge plan including a merge trajectory and/or a negotiation trajectory for negotiating and merging with traffic.

If the criterion is satisfied, e.g., during determining 606, the process 600 includes selecting one or more options for execution. The process 600 may include executing 622 a deceleration operation to slow down the vehicle 100 or cause the vehicle 100 to stop. Alternatively, the process 600 may include executing 620 the second planning methodology 142. The process 600 may include selecting from the options base on one or more threshold or criterion. For example, if the vehicle controller 110 determines that the distance to the tapered portion 322 of the merge lane 310 is less than a minimum merge lane threshold, the controller may select the deceleration operation.

The process 600 continues by determining 602 if there is a kinematically feasible merge gap, e.g., after selection and execution of either the deceleration operation or execution of the second planning methodology 142. If a kinematically feasible merge gap is determined 602, then the vehicle controller 110 selects a target merge gap, from available kinematically feasible merge gaps, and executing 604 the first planning methodology to determine a merge plan for the target merge gap. In some embodiments, the process 600 includes at least one of transmitting or executing the merge plan causing the vehicle 100 to merge into the target merge gap.

Any or all of the process 600 may be performed continuously or semi-continuously. For example, the vehicle controller 110 may execute determining 602 multiple times and/or continuously during the process 600.

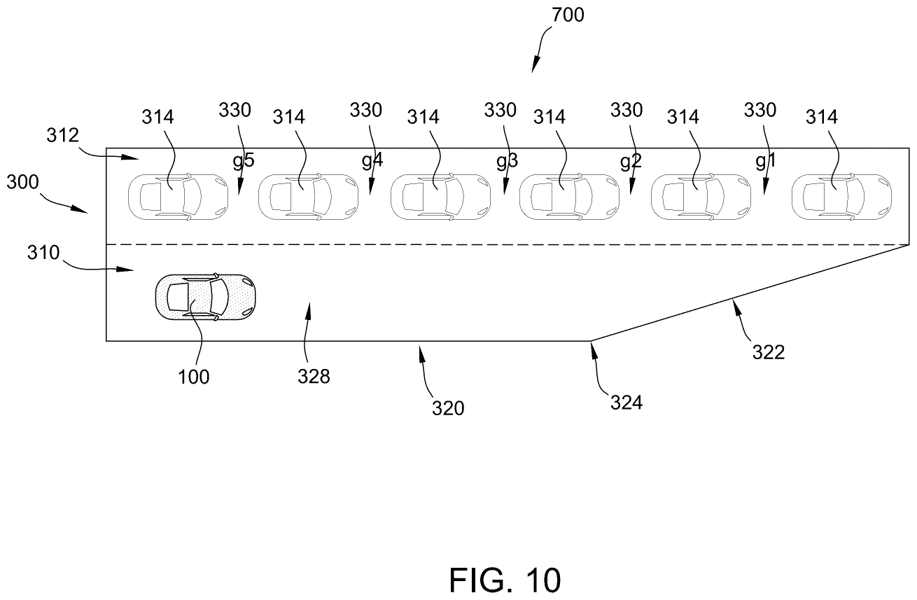

FIG. 10 shows another exemplary merge scenario 700 where the vehicle 100 is merging with heavier traffic, e.g., during rush-hour, where the traffic vehicles 314 are traveling at a slower speed as compared to traffic speeds during light or free-flowing traffic and/or the traffic vehicles 314 are traveling closer together. In the example merge scenario 700, initially there is no feasible merge gap, and the methodology selecting criterion is not satisfied. The vehicle controller 110 may execute the first planning methodology 140 to determine a set of potential gaps 330, labeled gaps g5, g4, g3, g2, and g1. The set of gaps 330 may be selected or determined by the vehicle controller 110 using a relative velocity to determine gaps 330 which have a positive rate (r_{g}=ġ₁=v₁−v₂>0), wherein ġ₁ is the gap rate of a first gap g1, v₁ is a velocity of a lead vehicle 334 and v₂ is a velocity of a following vehicle 332. For example, the vehicle controller 110 may only select gaps 330 to be included in the set, if the gap rate is positive, e.g., the gap length is not decreasing. Gap rate may be the rate at which a gap size is changing which may be calculated by determining a difference in velocity between the lead vehicle 334 and the following vehicle 332 defining a gap 330 therebetween, e.g., ġ=v₁−v₂. The vehicle controller 110 may then determine a gap trajectory T_{g} (e.g., a longitudinal gap trajectory) for each of the gaps contained in the set of gaps. In some embodiments, the gap trajectory T_{g} includes

$${T}_{g}^{hv} = \{ ( ( {t}_{1} , {p}_{1}^{hv} , {v}_{1}^{hv} ) , ( {t}_{2} , {p}_{2}^{hv} , {v}_{12}^{hv} ) … ( {t}_{i} , {p}_{i}^{hv} , {v}_{i}^{hv} ) \}$$

wherein, t is the time, p is the position and v is the velocity.

In some embodiments, the gap trajectory T_{g} may be associated with the merge plan, e.g., include the merge path, merge velocity, and acceleration (or a rate of change of the acceleration, e.g., jerk). The vehicle controller 110 may also determine, or predict, a trajectory

$${T}_{g}^{-}$$

for one or more of the traffic vehicles 314 associated with the gaps 330 in the set. The trajectory prediction for the vehicle 100 may include the vehicle controller 110 executing an extended intelligent driver model (IDM) to project the vehicle 100 to the target lane to act as a leader. In some embodiments, the vehicle controller 110 may assume a constant acceleration to predict trajectories

$${T}_{g}^{-}$$

for one or more of the traffic vehicles 314, e.g., using a simple, heuristic approach. The vehicle controller 110 may then score each of T_{g},

$${T}_{g}^{-} ,$$

and r_{g} and store these parameters, e.g., in memory 106. The scoring may be associated with a merge efficiency, lower accelerations, or time, for the vehicle 100 to merge with the gap 330. The vehicle controller 110 may then select a target merge gap and determine a merge plan for the target merge gap.

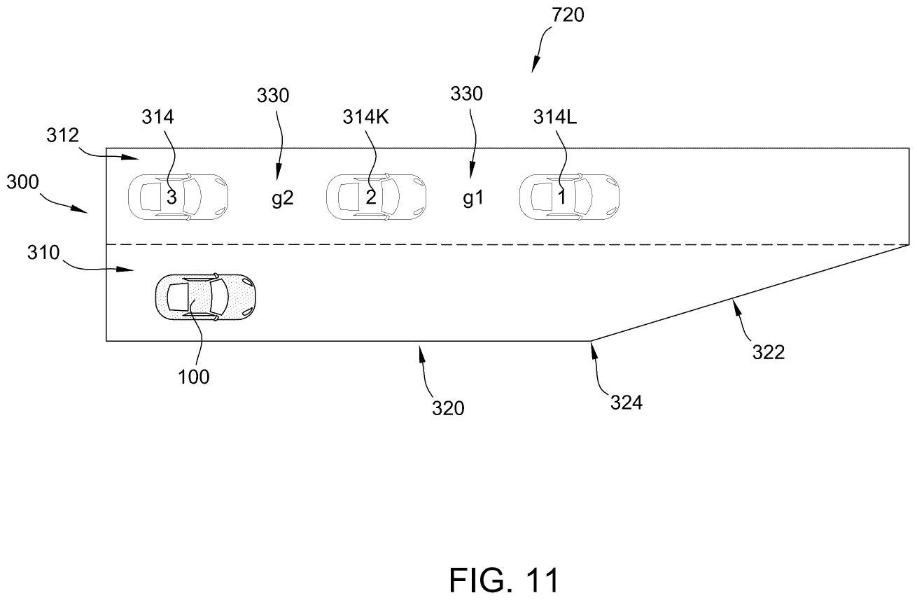

FIG. 11 shows another exemplary merge scenario 720 where the vehicle 100 is merging with traffic. In the example merge scenario 720, initially there is no feasible merge gap, and the methodology switching criterion 138 is not satisfied. The vehicle controller 110 may execute the third methodology 144 and the vehicle controller 110 determines a trajectory for each potential gap 330 contained in the set. In the merge scenario 720, the vehicle controller 110 determines a gap trajectory

$${T}_{g}^{hv}$$

(e.g., a longitudinal trajectory for the vehicle 100 (hv)) for the vehicle 100 to merge with the gaps 330 in the set. For example, the vehicle controller 110 determines a first gap trajectory

$${T}_{g 1}^{hv}$$

for the vehicle 100 to merge with g1. The vehicle controller 110 may determine one or more waypoints for the gap trajectories

$${T}_{g}^{hv} ,$$

For example, the controller determines n-number of waypoints for the first gap trajectory

$${T}_{g 1}^{hv} = \{ ( {t}_{1} , {p}_{1}^{hv} , {v}_{1}^{hv} ) , ( {t}_{2} , {p}_{2}^{hv} , {v}_{2}^{hv} ) , … , ( {t}_{n} , {p}_{n}^{hv} , {v}_{n}^{hv} ) \} , where {p}_{n}^{hv}$$

is a position of the vehicle 100 at a time instance n. In the merge scenario 720, the vehicle controller 110 may select a target traffic vehicle 314 to negotiate with, for example, the vehicle controller 110 may negotiate with the target traffic vehicle 314 to cause the target traffic vehicle 314 to react, e.g., decelerate, to cause a target gap g₁ to increase in length.

In some embodiments, the vehicle controller 110 may predict reactions of other traffic vehicle 314 in relation to each gap trajectories. For example, the vehicle controller 110 may determine traffic trajectories

$${T}_{gn}^{TVn}$$

for traffic vehicles 314 associated with a gap gₙ. The vehicle controller 110 may predict reaction of a lead traffic vehicle 314 L, ahead of a target traffic vehicle 314 K, e.g., the target vehicle 314 K is associated with a potential merge gap. The vehicle controller 110 determines a position and/or a speed of the lead traffic vehicle 314 L, e.g., using an estimated constant speed assumption. The vehicle controller 110 may also project the speed and position of the vehicle 100 at the time instant i (where i is a time step and includes i=0, 1, 2, 3, . . . , n−1) from actual values of position

$${p}_{i}^{hv}$$

and velocity

$${v}_{i}^{hv}$$

of the vehicle 100. The vehicle controller 110 may initialize an acceleration variable

$${a}_{i , 1}^{K}$$

of the target traffic vehicle 314 K and using the state of target traffic vehicle 314 K and leading vehicle 314 L, at time i, the vehicle controller 110 predicts the acceleration

$${a}_{i , 2}^{K}$$

of the target traffic vehicle 314 K, e.g., using IDM. The controller may then determine if the vehicle 100 will be in front of the target gap using the predicted acceleration, velocity, and/or the position of the target traffic vehicle 314 K and the projected position and velocity of the vehicle 100. If the vehicle 100 predicted to not be in front of the target merge gap, the vehicle controller 110 determines a subsequent velocity of the target vehicle and a subsequent position of the target vehicle, which are functions of the predicted acceleration. In some embodiments, the controller may select a minimum accelerations

$${a}_{i , 1}^{K} and {a}_{i , 2}^{K} .$$

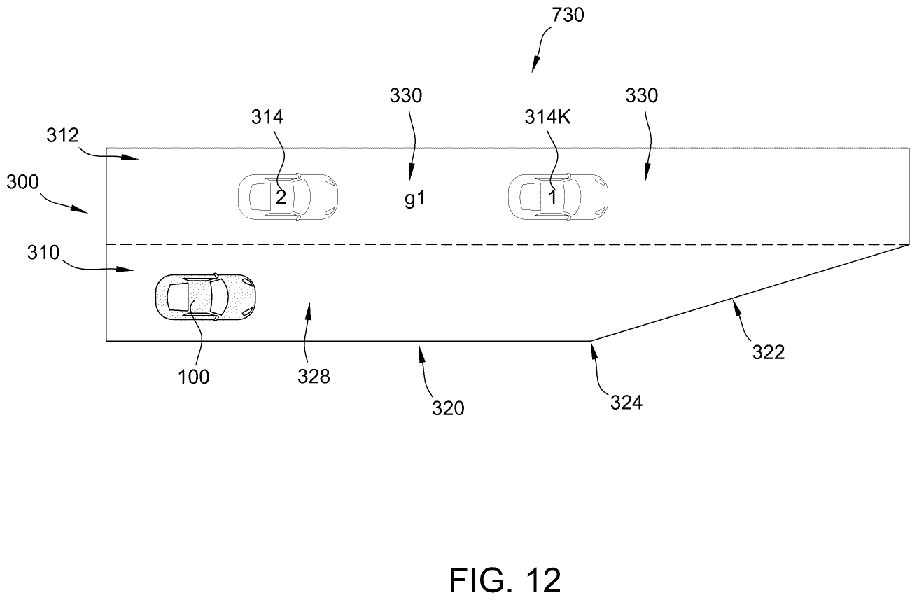

In reference to FIG. 12, the vehicle controller 110 may score each of the gap trajectories, and the traffic vehicle 314 trajectories, to determine a target merge gap and determine a merge plan for the target merge gap. In the example shown in FIG. 12, the vehicle controller 110 determines a trajectory of the vehicle 100 to a first gap g1,

$${T}_{g 1}^{hv} ,$$

a trajectory of a following traffic vehicle 314 associated with the first gap g1,

$${T}_{g 1}^{tv 2} ,$$

and a trajectory of a leading traffic vehicle 314 associated with the first gap g1,

$${T}_{g 1}^{tv 1} ,$$

Ifor each of the potential gaps contained in the set. The vehicle controller 110 may also determine a R_{gn} for each of the potential gaps in the set, where R_{gn}=w₁r₁+w₂r₂+w₃r₃, where r₁ is the gap size, e.g., gap length, r₂ is the headway (e.g., the distance or duration between traffic vehicle 314s), and r₃ is the distance between the vehicle 100 to the end 324 of the merge lane 310 or to the tapered portion 322 of the merge lane 310, and where w₁, w₂, and w₃ are weighting factors. The vehicle controller 110 may score each of the potential gaps based on

$${T}_{gn}^{hv} , {T}_{g 1}^{tv 1} , {T}_{g 1}^{tv 2} ,$$

and R_{gn}. The vehicle controller 110 may compare the scores to determine a target gap, e.g., the gap with the highest score, and then the vehicle controller 110 creates a merge plan, including the gap trajectory

$${T}_{gn}^{hv}$$

which is then transmitted or executed by the vehicle 100 causing the vehicle 100 to follow the merge plan.

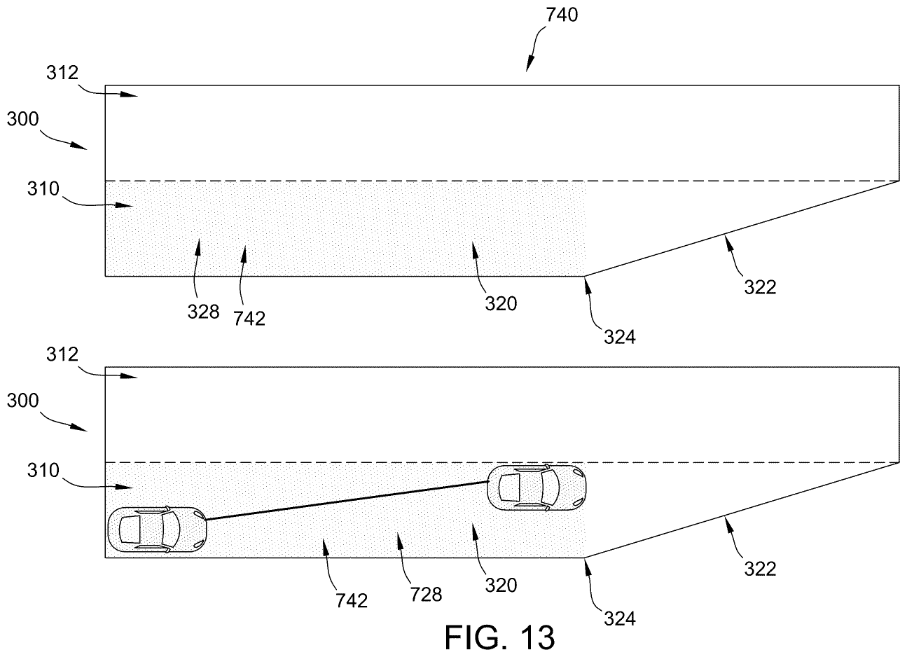

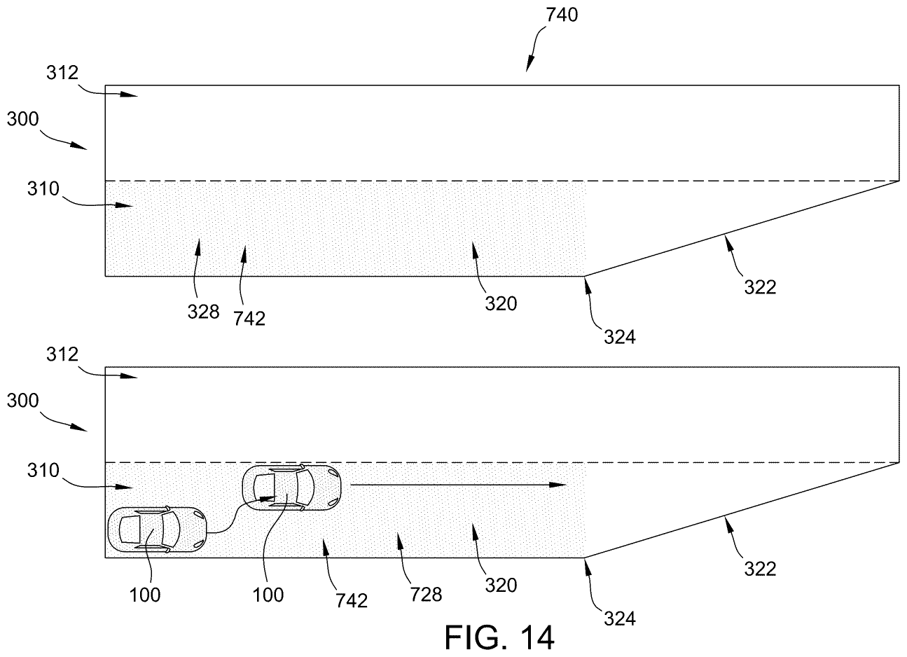

In reference to FIGS. 13 and 14, shows another exemplary merge scenario 740 where the vehicle 100 is merging into an adjacent traffic lane 312 and the vehicle controller 110 is executing the third methodology 144 causing the vehicle 100 to move lateral from a first side of the merge lane 310 to a second side of the merge lane 310 adjacent to the adjacent traffic lane 312. In some embodiments, the lateral motion of the vehicle 100, during the third methodology 144 may be generally linear along the length of the merge lane 310, e.g., till the end 324 of the straight portion or before the tapered portion 322. FIG. 13. In some embodiments, the lateral motion may include the vehicle 100 moving towards the adjacent traffic lane, without going over the lane lines, and traveling adjacent to the lane line over the length of the merge lane 310. FIG. 14. In some embodiments, the vehicle controller 110 may designate a portion of the merge lane 310 as a negotiation region 742, where negotiation maneuvers may safely take place, e.g., before the end 324 or before the tapered portion 322 of the merge lane 310.

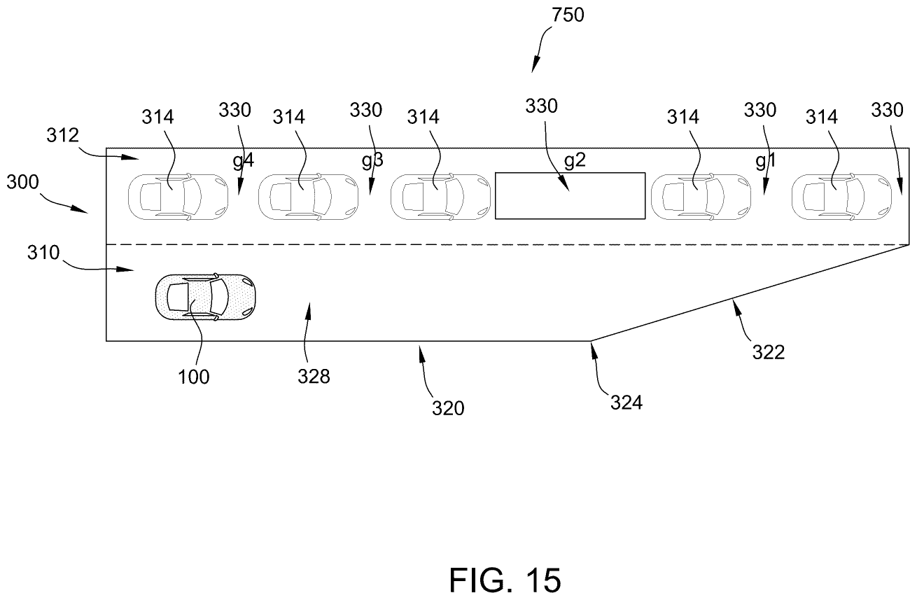

FIG. 15 shows another exemplary merge scenario 750 where the vehicle controller 110 may execute the first planning methodology 140 and determine that a kinematically feasible merge gap is available, e.g., g2 in FIG. 15. The vehicle controller 110 may determine a trajectory

$${T}_{g 2}^{hv}$$

for the vehicle 100 to reach the gap g2. In some embodiments, the vehicle controller 110 may determine the trajectory

$${T}_{g 2}^{hv}$$

assuming that that one or more of the traffic vehicles 314 are traveling at a constant speed.

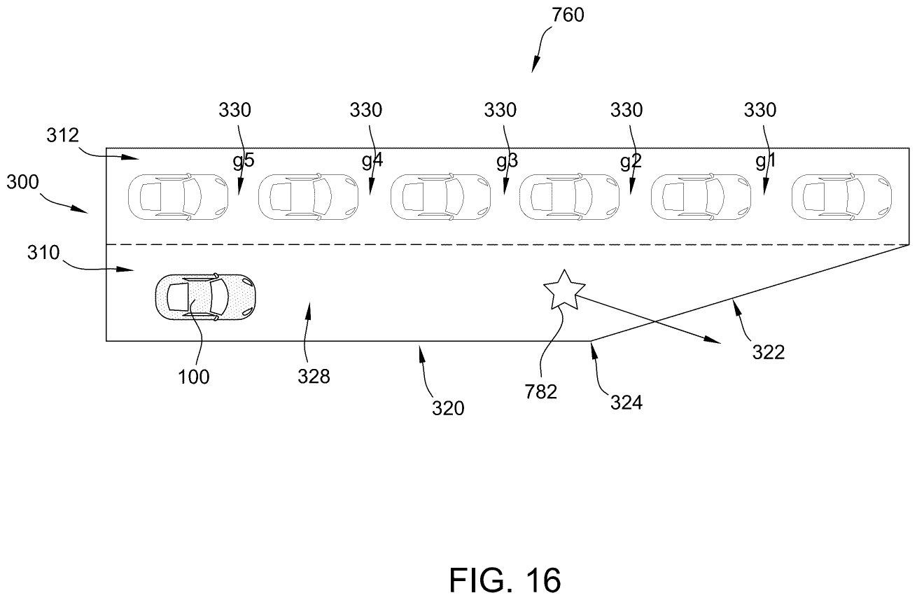

FIG. 16 shows another exemplary merge scenario 760, similar to the merge scenario 700 shown in FIG. 10, where the vehicle controller 110 executes the first planning methodology 140 and determines that there is not, at least initially, a kinematically feasible merge gap. In some embodiments, the vehicle controller 110 may determine and/or set a critical location 782 on the merge lane 310. If the vehicle 100 reaches or approaches the critical location 782, the vehicle controller 110 determines one or more control signals for causing the vehicle 100 to slow down, e.g., to a complete stop, if a merge plan has not been executed. In some embodiments, the vehicle controller 110 may determine the one or more control signals for causing the vehicle 100 to slow down if the vehicle controller 110 determines that there is no target merge gap. In some embodiments, the critical location 782 is before the end 324 of the merge lane 310 and before the tapered portion 322 of the merge lane 310. In some embodiments, the vehicle controller 110 may determine or set the critical location 782 based on the speed of the vehicle 100, the number of gaps in the set, and/or the speed of one or more of the traffic vehicles 314.

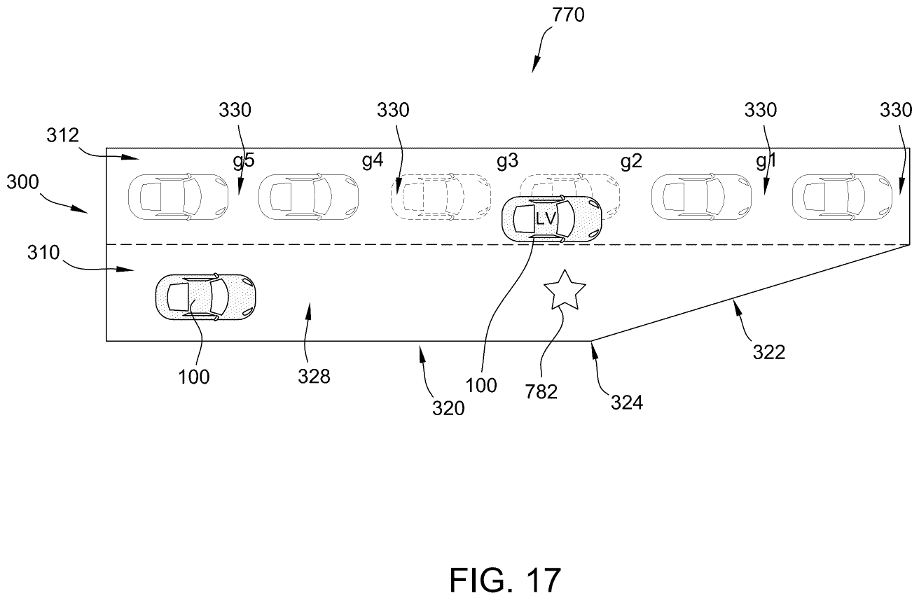

FIG. 17 shows another exemplary merge scenario 770 showing exemplary merge lane thresholds. The vehicle controller 110 initially determines that there is not a kinematically feasible merge gap and the vehicle controller 110 determines that the methodology switching criterion 138 has not yet been satisfied, and the vehicle controller 110 executes the third methodology 144 to perform one or more negotiation maneuvers prior to the vehicle 100 reaching the critical location 782.

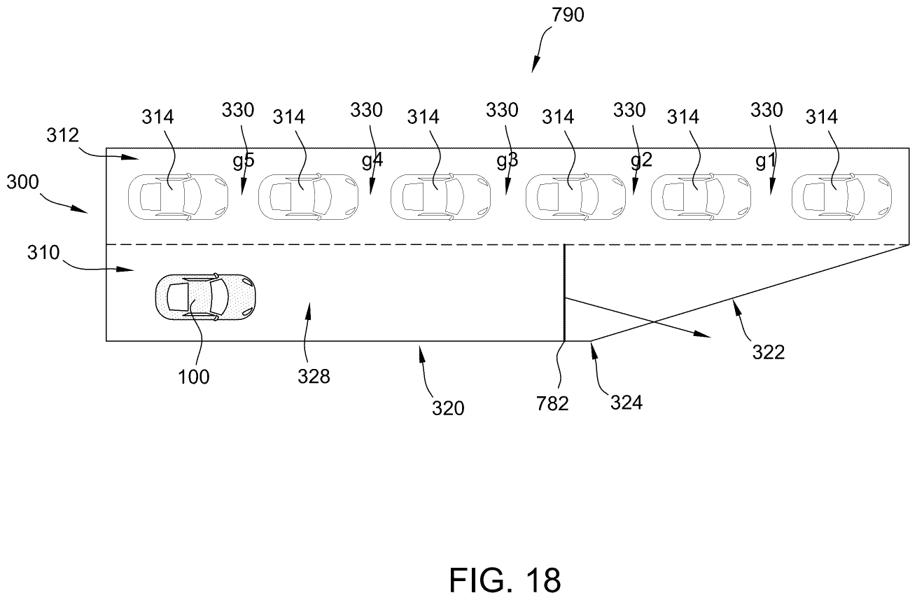

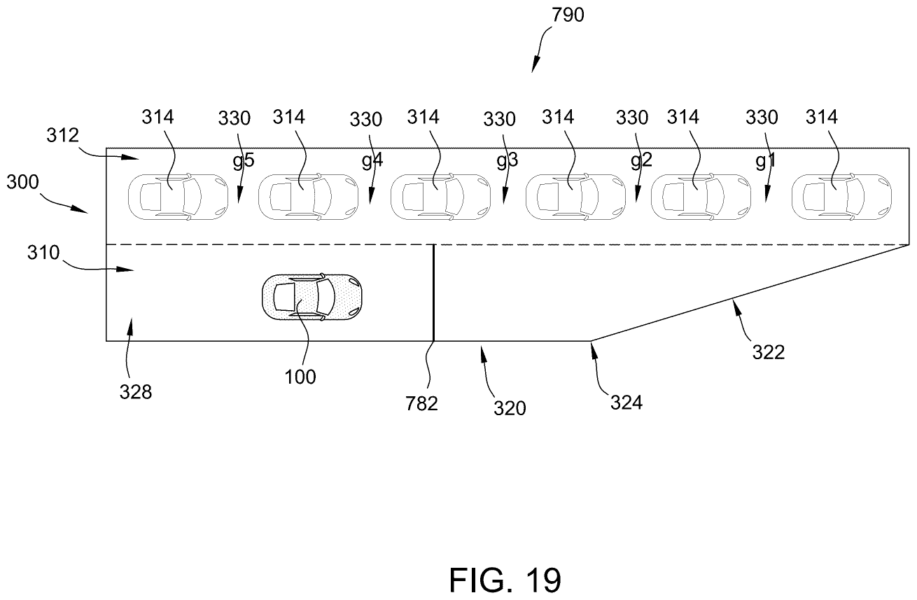

FIGS. 18 and 19 shows another example merge scenario 790 showing another exemplary critical location 782, located before the end 324 of the adjacent lane portion 320 and/or before the tapered portion 322. In some embodiments, the critical location 782 denotes the point at which the vehicle 100 needs to slow down or come to a stop if a merge plan has not yet been executed. In some other embodiments, the vehicle 100 needs to come to a stop before or at the critical location 782. In some embodiments the vehicle controller 110 determines the critical location 782 based on merge parameters, such as vehicle 100 speed, traffic density, traffic speed, merge lane geometry, remaining merge lane length, normalize merge travel distance, traffic vehicle 314 speeds, etc.

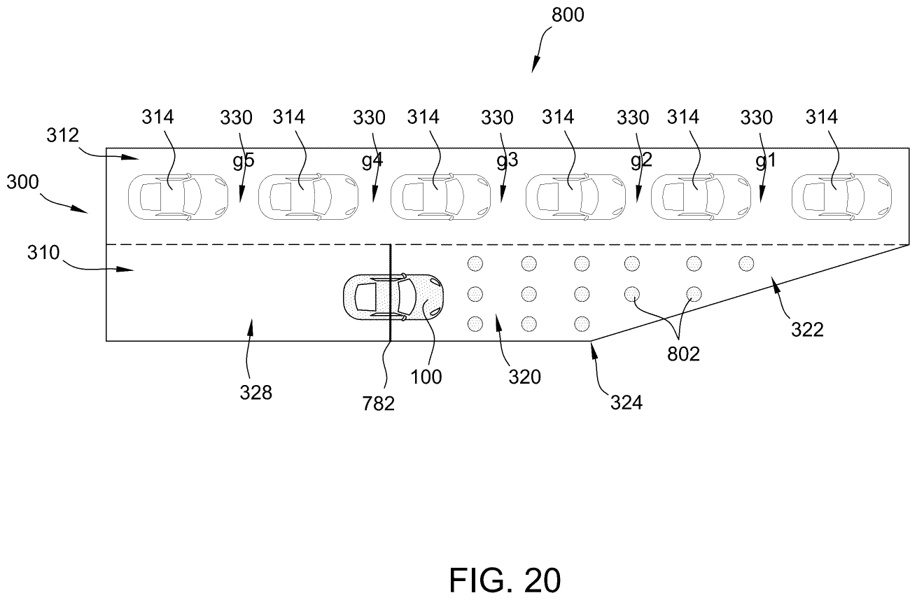

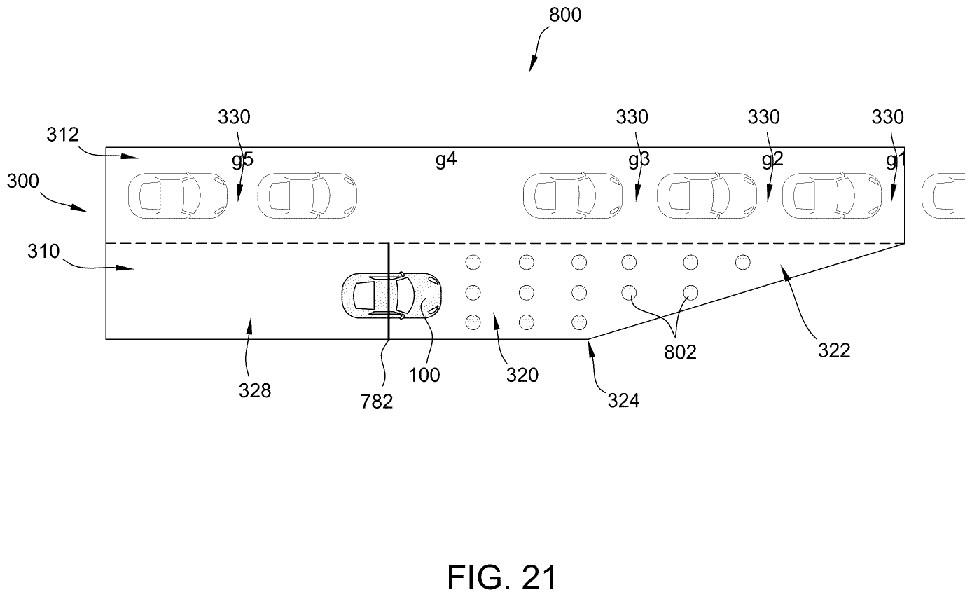

FIG. 20-21 shows another exemplary merge scenario 800 showing lattice points 802 determined when the vehicle controller 110 executes the second planning methodology 142, e.g., after the vehicle controller 110 determines that there are no kinematically feasible merge gaps available. The vehicle controller 110 also determines that the methodology switching criterion 138 is satisfied. For example, the vehicle controller 110 may compare sensor data to the switching criterion 138 to determine if the criterion is satisfied. The vehicle controller 110 may then execute the second planning methodology 142 to determine a target merge gap. In some embodiments, the second planning methodology 142 may include determining lattice points 802, arranged in a grid pattern with rows and columns, and determining potential trajectories for each of the lattice points 802.

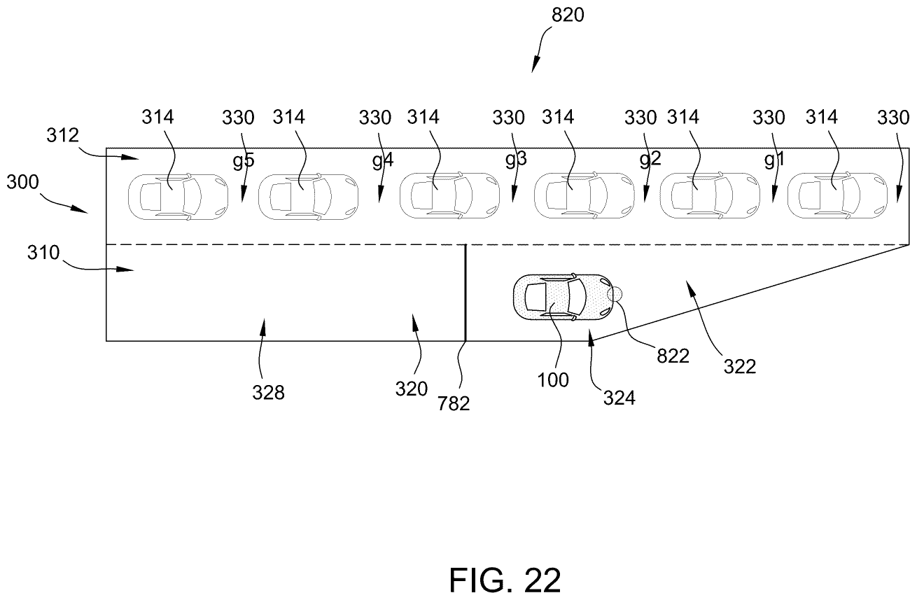

FIG. 22 shows another exemplary merge scenario 820, where the vehicle 100 has exceeded the critical location 782, and the vehicle controller 110 causes the vehicle 100 to slow down to a stop, before the vehicle 100 reaches the tapered portion 322 and/or the end 324 of the merge lane 310. In some embodiments, the vehicle controller 110 may set a marker 822, e.g., a reference or datum, by which the vehicle controller 110 may use to compare against merge lane parameters, e.g., the merge lane end or tapered portion.

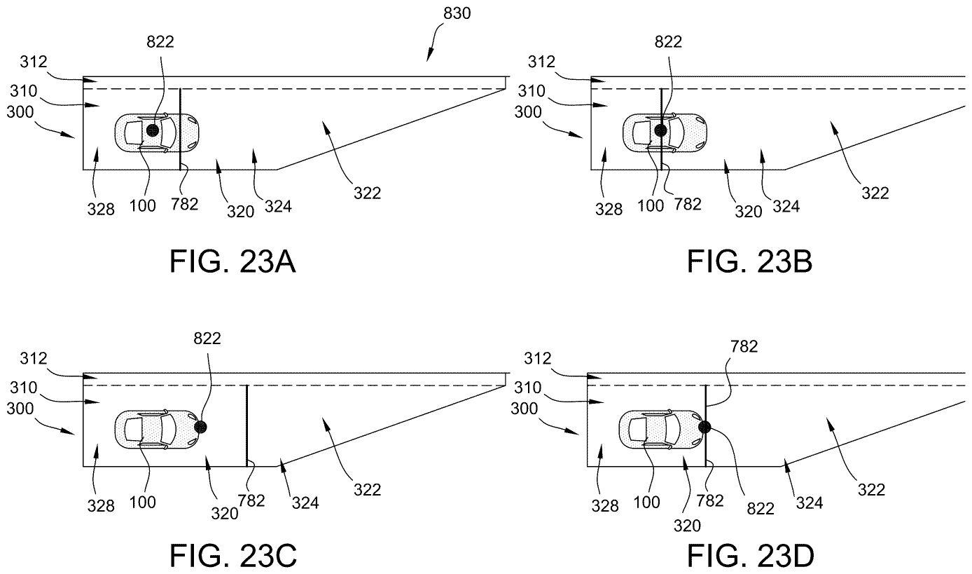

FIGS. 23A-B shows another exemplary merge scenario 830 where the vehicle 100 includes a marker 822 at a front end of the vehicle 100. In FIGS. 23C and D, a marker 822 is positioned at a center of the vehicle 100. The vehicle controller 110 may utilize the marker 822 to compare the critical location 782.

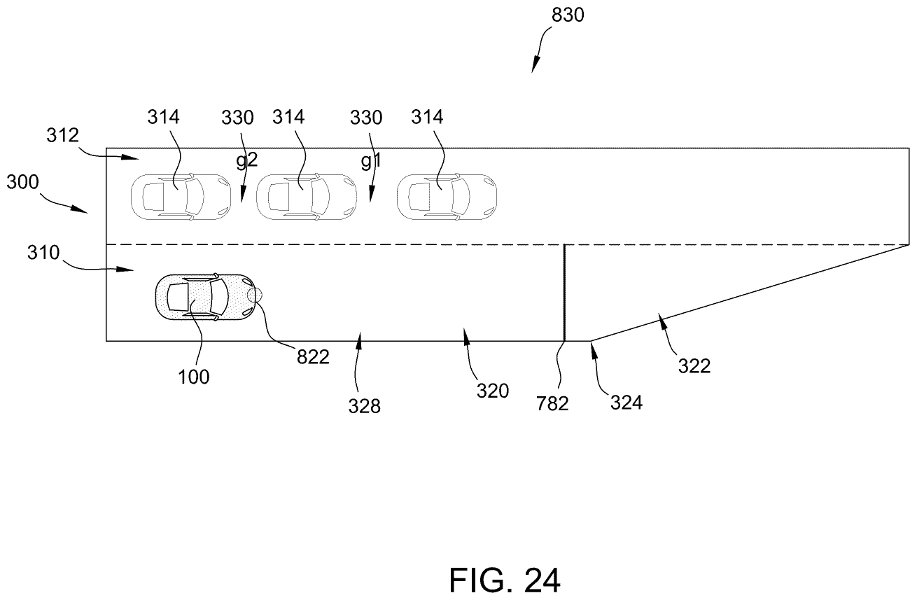

FIGS. 24-26 shows exemplary merge scenarios 840 which may be averted using the merge planning module described herein. For example, in FIG. 24, the vehicle 100 is approaching a critical location 782. The vehicle controller 110 may determine that gap g1 is not a kinematically feasible merge gap, but rather gap g1 is a potential merge gap, e.g., the most efficient merge gap of the detected merge gaps. The vehicle controller 110 may also determine a time to threshold (TTT) associated with the time left before the marker 822, positioned on the vehicle 100, will reach the critical location 782. The vehicle controller 110 may determine the TTT using a longitudinal speed of the vehicle 100. In some embodiments, the vehicle controller 110 may use the TTT as a parameter to be included in the switching criterion 138.

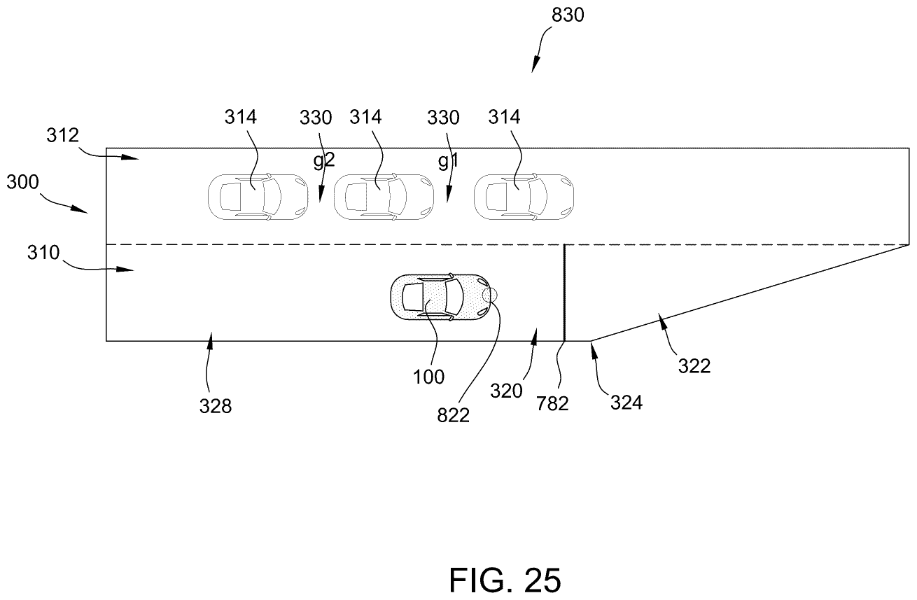

In further reference to FIG. 25, vehicle 100 has now executed a third methodology 144 causing the vehicle 100 to be positioned adjacent to gap g1, e.g., the potential merge gap, before the marker 822 has reached the critical location 782. In this example merge scenario, the negotiation maneuver increases the length of gap g1, e.g., by causing the traffic vehicles 314 to slow down, speed up, and/or change lanes.

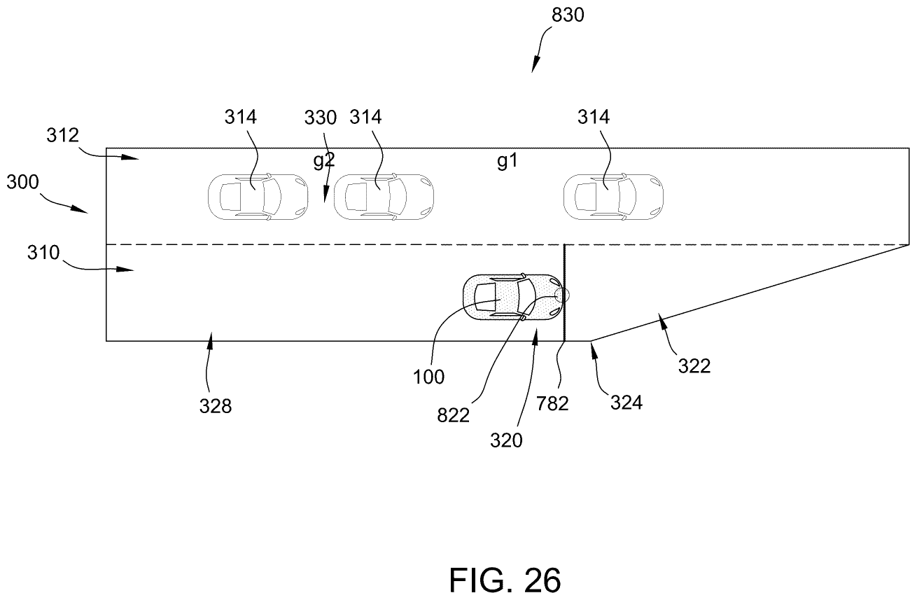

In further reference to FIG. 26, the marker 822 of the vehicle 100 reaches the critical location 782 prior to the merge gap g1 increasing to a suitable length, e.g., the gap g1 does not become kinematically feasible, which may be avoided using the merge module 120 described herein. For example, the merge module 120 would have determined that the second planning methodology 142 is required, e.g., determining that the switching criterion 138 is satisfied. For example, one or more of the merge methodologies may determine a buffer time estimate in the gap 330 selection process that accounts for time and distance needed for the gap g1 to become kinematically feasible.

For the methods described above, the wireless communication-based autonomous or semi-autonomous vehicle technology or functionality may include and/or be related to: automatic or semi-automatic steering; automatic or semi-automatic acceleration and/or braking; automatic or semi-automatic blind spot monitoring; automatic or semi-automatic collision warning; adaptive cruise control; and/or automatic or semi-automatic parking assistance. Additionally, or alternatively, the autonomous or semi-autonomous technology or functionality may include and/or be related to: driver alertness or responsive monitoring; pedestrian detection; artificial intelligence and/or back-up systems; navigation or GPS-related systems; security and/or anti-hacking measures; and/or theft prevention systems.

The computer-implemented methods and processes described herein may include additional, fewer, or alternate actions, including those discussed elsewhere herein. The present systems and methods may be implemented using one or more local or remote processors, transceivers, and/or sensors (such as processors, transceivers, and/or sensors mounted on vehicles, stations, nodes, or mobile devices, or associated with smart infrastructures and/or remote servers), and/or through implementation of computer-executable instructions stored on non-transitory computer-readable media or medium. Unless described herein to the contrary, the various portions of the several processes may be performed in a different order, or simultaneously in some instances.

Additionally, the computer systems discussed herein may include additional, fewer, or alternative elements and respective functionalities, including those discussed elsewhere herein, which themselves may include or be implemented according to computer-executable instructions stored on non-transitory computer-readable media or medium.

In the exemplary embodiment, a processing element may be instructed to execute one or more of the processes and subprocesses described above by providing the processing element with computer-executable instructions to perform such steps/sub-steps, and store collected data (e.g., vehicle profiles, etc.) in a memory or storage associated therewith. This stored information may be used by the respective processing elements to make the determinations necessary to perform other relevant processing, as described above.

The aspects described herein may be implemented as part of one or more computer components, such as a client device, system, and/or components thereof, for example. Furthermore, one or more of the aspects described herein may be implemented as part of a computer network architecture and/or a cognitive computing architecture that facilitates communications between various other devices and/or components. Thus, the aspects described herein address and solve issues of a technical nature that are necessarily rooted in computer technology.

The exemplary systems and methods described and illustrated herein therefore significantly increase the safety of operation of autonomous and semi-autonomous vehicles by reducing risks associated with such a vehicle approaching a traffic dense environment and by reducing the likelihood of potential risks within the vehicle's surroundings.

The present systems and methods are further advantageous over conventional techniques the embodiments herein are not confined to a single type of vehicle and/or situation but may instead allow for versatile operation within multiple different types of vehicles, including ground craft, watercraft, aircraft, and spacecraft. Accordingly, these novel techniques are of particular value to vehicle manufacturers who desire to have these methods and systems available for the users of their vehicles.

Exemplary embodiments of systems and methods for securely navigating intersections are described above in detail. The systems and methods of this disclosure though, are not limited to only the specific embodiments described herein, but rather, the components and/or steps of their implementation may be utilized independently and separately from other components and/or steps described herein.

Although specific features of various embodiments may be shown in some drawings and not in others, this is for convenience only. In accordance with the principles of the systems and methods described herein, any feature of a drawing may be referenced or claimed in combination with any feature of any other drawing.

Some embodiments involve the use of one or more electronic or computer devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a programmable logic unit (PLU), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A vehicle comprising:
a sensor configured to collect data associated with a merge scenario, wherein the data includes data associated with at least one traffic vehicle; and
a controller comprising at least one memory configured to store program instructions and at least one processor configured to execute the program instructions, wherein the controller is programmed to:
execute a first planning methodology, using data received from the sensor, to determine if there is at least one kinematically feasible merge gap defined by at least one traffic vehicle; and
if the controller determines that there is at least one kinematically feasible merge gap, then the controller:
identifies a target merge gap that includes one of the at least one determined kinematically feasible merge gap, and determines a merge plan for merging with the target merge gap; and
if the controller determines that there is not at least one feasible merge gap, the controller compares the data to a switch criterion to determine if a second planning methodology is required.

2. The vehicle of claim 1, wherein:
if the switch criterion is satisfied, the controller executes the second planning methodology using received data to identify a target merge gap; and
if the switch criterion is not satisfied, the controller re-executes the first planning methodology.

3. The vehicle of claim 1, wherein if the controller determines that there is not at least one feasible merge gap and the controller determines that the switch criterion is not satisfied, the controller is further programmed to execute a negotiation methodology to negotiate with at least one traffic vehicle to generate a kinematically feasible merge gap.

4. The vehicle of claim 1, wherein the controller compares data to a switch criterion that includes at least one of a length of remaining merge lane length, a normalized distance traveled on a merge lane, a merge lane geometry, a number of traffic vehicles, speed(s) of traffic vehicles, a gap(s) distances, and a traffic density.

5. The vehicle of claim 1, wherein the controller is programmed to determine the merge plan including at least one of a merge trajectory, a merge velocity, and a merge acceleration/deceleration.

6. The vehicle of claim 1, wherein the controller is further programmed to select the target merge gap from a plurality of kinematically feasible merge gaps by determining a merge efficiency for each of the plurality of kinematically feasible merge gaps.

7. The vehicle of claim 1, wherein the controller determines at least one control signal for controlling operation of the vehicle to cause the vehicle to execute the merge plan.

8. The vehicle of claim 1, wherein the sensor is at least one of a video device, an imaging device, and a camera.

9. The vehicle of claim 1, wherein the sensor is at least one of a radar, a proximity sensor, an ultrasonic sensor, an electromagnetic sensor, a wide RADAR, a long-distance RADAR, a Global Positioning System (GPS), a video device, an imaging device, a camera, an audio recorder, and a computer vision.

10. The vehicle of claim 1, wherein when executing the second planning methodology, the controller is further programmed to:
select a set of potential gaps defined by the at least one traffic vehicle;
generate a merge plan for each of the potential gaps, wherein each merge plan includes a merge trajectory for each of the selected potential gaps, and wherein each merge trajectory is generated using a predicted reaction of at least one traffic vehicle;
score each of the merge plans; and
identify the target merge gap based on, at least in part, the scores of each of the merge plans.

11. The vehicle of claim 10, wherein the controller determines the score of the merge plans using a merge efficiency, wherein the merge efficiency is based on at least one of vehicle acceleration, vehicle jerk, vehicle normalized merge distance traveled, headway between traffic vehicles, and time to collision with at least one traffic vehicle.

12. A control system for controlling a vehicle, wherein the control system comprises:
a computer device comprising:
at least one memory; and
at least one processor in communication with the at least one memory, the at least one processor programmed to:
execute a first planning methodology, using data received from a sensor, to determine if there is at least one kinematically feasible merge gap defined by at least one traffic vehicle; and
if the controller determines that there is at least one kinematically feasible merge gap, then the controller:
identifies a target merge gap that includes one of the at least one determined kinematically feasible merge gaps, and determines a merge plan for merging with the target merge gap; and
if the controller determines that there is not at least one feasible merge gap, the controller compares sensor data to a switch criterion to determine if a second planning methodology is required.

13. The control system of claim 12, wherein:
if the switch criterion is satisfied, the controller executes the second planning methodology using received sensor data to identify the target merge gap; and
if the switch criterion is not satisfied, the controller re-executes the first planning methodology.

14. The control system of claim 12, wherein if the controller determines that there is not at least one feasible merge gap and the controller determines that the switch criterion is not satisfied, the controller is further programmed to execute a negotiation methodology to negotiate with at least one traffic vehicle to generate a kinematically feasible merge gap.

15. The control system of claim 12, wherein the controller compares sensor data to a switch criterion that includes at least one of a length of remaining merge lane length, a normalized distance traveled on a merge lane, a merge lane geometry, a number of traffic vehicles, speed(s) of traffic vehicles, a gap(s) distances, and a traffic density.

16. A method for controlling a vehicle using a controller associated with the vehicle, the method comprising:
executing a first planning methodology, using data received from at least one sensor, to determine if there is at least one kinematically feasible merge gap defined by at least one traffic vehicle; and
if the controller determines that there is at least one kinematically feasible merge gap, then the controller:
identifies a target merge gap that includes one of the at least one determined kinematically feasible merge gaps, and determines a merge plan for merging with the target merge gap; and
if the controller determines that there is not at least one feasible merge gap, the controller compares sensor data to a switch criterion to determine if a second planning methodology is required.

17. The method of claim 16, wherein:
if the switch criterion is satisfied, the controller executes the second planning methodology using received sensor data to identify the target merge gap; and
if the switch criterion is not satisfied, the controller re-executes the first planning methodology.

18. The method of claim 16, wherein the method includes determining that there is not at least one feasible merge gap and the controller determines that the switch criterion is not satisfied, the controller is further programmed to execute a negotiation methodology to negotiate with at least one traffic vehicle to generate a kinematically feasible merge gap.

19. The method of claim 16, wherein the method includes comparing sensor data to a switch criterion that includes at least one of a length of remaining merge lane length, a normalized distance traveled on a merge lane, a merge lane geometry, a number of traffic vehicles, speed(s) of traffic vehicles, a gap(s) distances, and a traffic density.

20. The method of claim 16, wherein the method includes determining the merge plan using at least one of a merge trajectory, a merge velocity, and a merge acceleration/deceleration.
